(19) United States
(12) Patent Application Publication
(10) Pub. No.: US 2017/0103697 A1
(43) Pub. Date: Apr. 13, 2017

(54) DISPLAY DEVICE AND DRIVING METHOD OF THE SAME

(71) Applicant: Semiconductor Energy Laboratory Co., Ltd., Atsugi-shi (JP)

(72) Inventors: Susumu KAWASHIMA, Atsugi (JP); Yoshiharu HIRAKATA, Tochigi (JP); Daisuke KUBOTA, Atsugi (JP)

(21) Appl. No.: 15/285,530

(22) Filed: Oct. 5, 2016

(30) Foreign Application Priority Data
Oct. 12, 2015 (JP) 2015-201650

(51) Int. Cl. G09G 3/20; G06F 1/32

(52) U.S. Cl. CPC G09G 3/2074; G09G 3/2003; G06F 1/3265; G09G 2320/062; G09G 2300/0809; G09G 2310/0237

(57) ABSTRACT

Power consumption of a display device is reduced. The display quality of the display device is improved. Video with high display quality is displayed regardless of the usage environment. The display device includes a first pixel performing display with reflected light, a second pixel including a light source and performing display with light from the light source, a driver portion driving the first pixel and the second pixel, a photometric portion measuring and outputting illuminance of the external light, and a control portion generating a first gray level output to the first pixel and a second gray level output to the second pixel on the basis of information of the illuminance input from the photometric portion and outputting the first and second gray levels to the driver portion. In addition, the control portion generates the first and second gray levels so that the first gray level is the largest among the combinations of the first and second gray levels at which chromaticity and luminance of light obtained by adding light output from the first pixel and light output from the second pixel have predetermined values.

### TECHNICAL FIELD

One embodiment of the present invention relates to a display device. One embodiment of the present invention relates to a method for driving a display device.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof.

In this specification and the like, a semiconductor device generally means a device that can function by utilizing semiconductor characteristics. A transistor, a semiconductor circuit, an arithmetic device, a memory device, and the like are each an embodiment of the semiconductor device. In addition, an imaging device, an electro-optical device, a power generation device (e.g., a thin film solar cell and an organic thin film solar cell), and an electronic device each may include a semiconductor device.

### BACKGROUND ART

As one of display devices, there is a liquid crystal display device provided with a liquid crystal element. For example, an active matrix liquid crystal display device, in which pixel electrodes are arranged in a matrix and transistors are used as switching elements connected to respective pixel electrodes, has attracted attention.

For example, an active matrix liquid crystal display device including transistors, in which metal oxide is used for a channel formation region, as switching elements connected to respective pixel electrodes is already known (Patent Documents 1 and 2).

It is known that an active matrix liquid crystal display device is classified into two major types: transmissive type and reflective type.

In the transmissive liquid crystal display device, a backlight such as a cold cathode fluorescent lamp or a light emitting diode (LED) is used, and optical modulation action of liquid crystal is utilized to select one of the two states: a state where light from the backlight passes through liquid crystal to be output to the outside of the liquid crystal display device and a state where light is not output to the outside of the liquid crystal display device, whereby a bright or dark image is displayed. Furthermore, those images are combined to perform image display.

In a reflective liquid crystal display device, a state in which external light, that is, incident light is reflected at a pixel electrode and output to the outside of the device or a state in which incident light is not output to the outside of the device is selected using optical modulation action of liquid crystal, whereby bright and dark images are displayed. Furthermore, those displays are combined to display an image. Compared to the transmissive liquid crystal display device, the reflective liquid crystal display device has the advantage of low power consumption since the backlight is not used.

### REFERENCE

### Patent Document

[Patent Document 1] Japanese Published Patent Application No. 2007-123861
[Patent Document 2] Japanese Published Patent Application No. 2007-096055

### DISCLOSURE OF INVENTION

It is required to reduce the power consumption of an electronic device including a display device is used. In particular, reducing the power consumption of display devices is needed in devices using batteries as power sources, such as mobile phones, smartphones, tablet terminals, smart watches, and notebook personal computers, because the display devices consume significant power in such devices.

An object of one embodiment of the present invention is to reduce the power consumption of a display device. Another object of one embodiment of the present invention is to improve the display quality of the display device. Another object of one embodiment of the present invention is to display a high-quality video regardless of a usage environment.

Note that the descriptions of these objects do not disturb the existence of other objects. In one embodiment of the present invention, there is no need to achieve all the objects. Other objects can be derived from the description of the specification and the like.

One embodiment of the present invention is a display device including a first pixel, a second pixel, a driver portion, a photometric portion, and a control portion. The first pixel is configured to perform display with reflected light. The second pixel includes a light source and is configured to perform display with light from the light source. The driver portion is configured to drive the first pixel and the second pixel. The photometric portion is configured to measure and output the illuminance of external light. The control portion is configured to generate a first gray level output to the first pixel and a second gray level output to the second pixel on the basis of information of the illuminance input from the photometric portion and output the first and second gray levels to the driver portion.

Furthermore, the control portion is preferably configured to generate the first and second gray levels so that the first gray level has the largest value among the combinations of the first and second gray levels at which the chromaticity and luminance of light obtained by adding light output from the first pixel and light output from the second pixel have predetermined values.

Furthermore, the control portion preferably includes an arithmetic portion and a memory portion. The memory portion is configured to store a table including data in which the illuminance is associated with the first and second gray levels. The arithmetic portion is configured to select data of the first and second gray levels corresponding to the illuminance from the table and output the data to the driver portion.

Alternatively, the photometric portion is preferably configured to measure and output the chromaticity of external light. Here, the control portion is preferably configured to generate the first and second gray levels on the basis of information of the illuminance and the chromaticity input from the photometric portion.

Alternatively, the photometric portion is preferably configured to measure and output the chromaticity of external light. Here, the control portion preferably includes an arithmetic portion and a memory portion. The memory portion is configured to store a table including data in which the illuminance and the chromaticity are associated with the first and second gray levels. The arithmetic portion is configured to select data of the first and second gray levels corresponding to the illuminance and the chromaticity from the table and output the data to the driver portion.

Another embodiment of the present invention includes a first step of measuring the illuminance of external light with a photometric portion, a second step of generating first and second gray levels on the basis of information of the illuminance with a control portion, and a third step of outputting from the control portion a first gray level to the first pixel and a second gray level to the second pixel and performing display with the first pixel and the second pixel in the same period. Here, the first pixel is configured to perform display with reflected light and the second pixel includes a light source and is configured to perform display with light from the light source.

Furthermore, the control portion preferably generates the first and second gray levels so that the first gray level has the largest value among the combinations of the first and second gray levels at which chromaticity and luminance of light obtained by adding light output from the first pixel and light output from the second pixel have predetermined values.

Furthermore, in the second step, the control portion preferably selects data of the first and second gray levels corresponding to the illuminance from a table including data in which the illuminance is associated with the first and the second gray levels.

Alternatively, the photometric portion preferably measures the chromaticity of external light in the first step, and the control portion preferably generates the first and second gray levels on the basis of information of the illuminance and the chromaticity in the second step.

Alternatively, the photometric portion preferably measures the chromaticity of external light in the first step, and the control portion preferably selects data of the first and second gray levels corresponding to the illuminance and the chromaticity from a table including data in which the illuminance and the chromaticity are associated with the first and second gray levels in the second step.

One embodiment of the present invention can reduce the power consumption of a display device. Furthermore, the display quality of the display device can be improved. Furthermore, a high-quality video can be displayed regardless of a usage environment.

Note that one embodiment of the present invention does not necessarily achieve all the effects listed above. Other effects will be apparent from and can be derived from the description of the specification, the drawings, the claims, and the like.

### BRIEF DESCRIPTION OF DRAWINGS

FIG. 1 is a block diagram of a display device of one embodiment.

FIGS. 2A to 2C illustrate pixel units of one embodiment.

FIG. 3 is a flow chart showing a method for driving a display device of one embodiment.

FIG. 4 is a block diagram of a display device of one embodiment.

FIG. 5 is a flow chart of a driving method of a display device of one embodiment.

FIGS. 6A and 6B illustrate a table of one embodiment.

FIGS. 7A and 7B illustrate a table of one embodiment.

FIGS. 8A and 8B each are an xy chromaticity diagram of one embodiment.

FIG. 9 illustrates an XYZ color space of one embodiment.

FIGS. 10A1, 10A2, 10B1, 10B2, 10C1, and 10C2 are XY projection views of an XYZ color space of one embodiment.

FIGS. 11A, 11B1, and 11B2 illustrate structure examples of a display panel of one embodiment.

FIG. 12 is a circuit diagram of a display panel of one embodiment.

FIG. 13 illustrates a structure example of a display panel of one embodiment.

FIG. 14 illustrates a structure example of a display panel of an embodiment.

FIGS. 15A1, 15A2, 15B1, 15B2, 15C1, and 15C2 illustrate structure examples of a transistor of one embodiment.

FIGS. 16A1, 16A2, 16A3, 16B1, and 16B2 illustrate structure examples of a transistor of one embodiment.

FIGS. 17A1, 17A2, 17A3, 17B1, 17B2, 17C1, and 17C2 illustrate structural examples of a transistor of one embodiment.

FIGS. 18A, 18B, 18C, 18D, 18E, 18F illustrate examples of electronic devices and a lighting device.

FIGS. 19A, 19B, 19C, 19D, 19E, 19F, 19G, 19H, and 19I illustrate examples of electronic devices of one embodiment.

FIGS. 20A, 20B, 20C, 20D, 20E, and 20F illustrate examples of electronic devices of one embodiment.

### BEST MODE FOR CARRYING OUT THE INVENTION

Embodiments will be described in detail with reference to the drawings. It will be readily appreciated by those skilled in the art that modes and details of the present invention can be modified in various ways without departing from the spirit and scope of the present invention. Thus, the present invention should not be construed as being limited to the description in the following embodiments and example.

Note that in structures of the present invention described below, the same portions or portions having similar functions are denoted by the same reference numerals in different drawings, and a description thereof is not repeated. Further, the same hatching pattern is applied to portions having similar functions, and the portions are not especially denoted by reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first,” “second,” and the like are used in order to avoid confusion among components and do not limit the number.

A transistor is a kind of semiconductor elements and can achieve amplification of current or voltage, switching operation for controlling conduction or non-conduction, or the like. A transistor in this specification includes an insulated-gate field effect transistor (IGFET) and a thin film transistor (TFT).

### Embodiment 1

In this embodiment, a structure example of a display device of one embodiment of the present invention and a driving method thereof will be described.

The display device of one embodiment of the present invention includes first pixels expressing gray scales by controlling the amount of reflected light, and second pixels including a light source and expressing gray scales by controlling the amount of light of the light source. The first pixels and the second pixels are arranged in a matrix to form a display portion. In addition, the display device preferably includes a driver portion for driving the first pixels and the second pixels. The driver portion preferably has a structure which can supply different signals to the first pixels and the second pixels and drive the pixels.

The number of the first pixels is preferably the same as that of and the second pixels, and the first pixels and the second pixels are preferably arranged in a display region with the same pitch. Here, the first pixel and the second pixel adjacent to each other can be collectively referred to as a pixel unit.

Furthermore, the first pixels and the second pixels are preferably mixed in the display region of the display device. Accordingly, as described later, an image displayed by a plurality of first pixels, an image displayed by a plurality of second pixels, and an image displayed by both the plurality of first pixels and the plurality of second pixels can be displayed in the same display region.

As a display element included in the first pixel, an element which performs display by reflecting external light can be used. Such an element does not include a light source and thus power consumption in display can be significantly reduced. As the display element included in the first pixel, a reflective liquid crystal element can be typically used. As the display element included in the first pixel, an element using a microcapsule method, an electrophoretic method, an electrowetting method, an Electronic Liquid Powder (registered trademark) method, or the like can be used other than a Micro Electro Mechanical Systems (MEMS) shutter element or an optical interference type MEMS element.

As a display element included in the second pixel, an element including a light source and performing display using light from the light source can be used. Since the luminance and the chromaticity of light emitted from such a pixel are not affected by external light, an image with high color reproducibility (a wide color gamut) and a high contrast, i.e., a clear image can be displayed. As the display element included in the second pixel, a self-luminous light-emitting element such as an organic light-emitting diode (OLED), a light-emitting diode (LED), and a quantum-dot light-emitting diode (QLED) can be used. Alternatively, a combination of a backlight that is a light source and a transmissive liquid crystal element controlling the amount of light transmitted from a backlight may be used as the display element included in the second pixel.

The first pixel includes subpixels emitting light of three colors of red (R), green (G), blue (B), for example. The second pixel also includes subpixels emitting three colors of red (R), green (G), and blue (B), for example. Note that the first pixel and the second pixel may each include subpixels of four colors or more. As the number of subpixels is increased, power consumption can be reduced and color reproducibility can be improved. The number of subpixels included in the first pixel is preferably equal to, but may be different from, that of subpixels included in the second pixel. As compared to the case where the first pixel and the second pixel have different numbers of subpixels, a driving method can be simplified in the case where the first pixel and the second pixel have the same number of subpixels.

Here, the range of colors that can be expressed by the first pixel is referred to as a color gamut C1. The range of colors that can be expressed by the second pixel is referred to as a color gamut C2.

Since the first pixel uses reflected light, the color gamut C1 which can be expressed by the first pixel changes in accordance with the illuminance and chromaticity of the external light entering the first pixel. In contrast, since the second pixel uses light from a light source, the color gamut C2 is not related to the illuminance of external light.

The color reproducibility of the second pixel can be higher than that of the first pixel. That is, the size of the color gamut C2 which can be expressed by the second pixel can be made larger than the size of the color gamut C1 which can be expressed by the first pixel. Specifically, the color gamuts can be set so that the color gamut C1 expressed by the first pixel is included in the color gamut C2 expressed by the second pixel. Especially, in the case where a self-luminous light-emitting element is used as a display element in the second pixel and a reflective liquid crystal element is used as a display element in the first pixel, the difference in size of these color gamuts is considerable.

In one embodiment of the present invention, a first mode in which an image is displayed by the first pixels, a second mode in which an image is displayed by the second pixels, and a third mode in which an image is displayed by the first pixels and the second pixels can be switched.

Since display can be performed using only reflected light in the first mode, a light source is unnecessary. Therefore, the first mode is a driving mode with extremely low power consumption and is effective in the case where, for example, external light has a sufficiently high illuminance and emits white light or light near white light.

Since display can be performed using light of the light source in the second mode, an extremely clear image can be displayed regardless of the illuminance and chromaticity of external light. For example, the second mode is effective in the case where the illuminance of external light is extremely low, such as during the night or in a dark room. When a bright image is displayed under weak external light, a user may feel that the image is too bright. To prevent this, an image with reduced luminance is preferably displayed in the second mode. Thus, not only a reduction in the luminance but also low power consumption can be achieved.

In the third mode, display can be performed using both light of the light source and reflected light. Specifically, the display device is driven so that light emitted from the first pixel and light emitted from the second pixel adjacent to the first pixel are mixed to express one color. In other words, the display device is driven so that one pixel unit expresses one color. Accordingly, a clearer image than that in the first mode can be displayed and power consumption can be made lower than that in the second mode. For example, the third mode is effective when the illuminance of external light is relatively low such as under indoor illumination or in the morning or evening, or when the external light does not represent a white chromaticity.

In the third mode, gray levels are supplied to the first pixels and the second pixels. When the first pixel and the second pixel each include three subpixels, the gray levels explained here include gray levels corresponding to red (R), green (G), and blue (B).

Here, in the case where one pixel unit expresses one color, a first gray level supplied to the first pixel and a second gray level supplied to the second pixel are complementary to each other and thus a plurality of combinations of gray levels exist. In the case where one pixel unit expresses a predetermined color, the second gray level supplied to the second pixels is uniquely determined by determining the first gray level supplied to the first pixel.

In one embodiment of the present invention, the gray levels are determined so that a gray level supplied to the first pixel is as large as possible and a gray level supplied to the second pixel is as small as possible in the case where one pixel unit expresses a color. Accordingly, among light output from the pixel unit, the proportion of light utilizing reflected light is maximized and that of light utilizing light of the light source is minimized; thus, power consumption can be reduced even when light with the same color and the same luminance is output from the pixel unit.

As described above, the color gamut C1 expressed by the first pixel utilizing reflected light changes in accordance with the illuminance and chromaticity of external light. Here, in one embodiment of the present invention, the photometric portion measuring the illuminance and chromaticity of external light is preferably provided. Then, the first and second gray levels are preferably determined in accordance with information of the illuminance and chromaticity of external light output from the photometric portion. In this manner, the display device can display a clear image at all times in accordance with the illuminance and chromaticity of external light and perform driving with low power consumption.

More specifically, the display device can include a display panel including the first and second pixels, the photometric portion, and the control portion. The control portion generates the first gray level output to the first pixel and the second gray level output to the second pixel based on information input from the photometric portion and image information input from the outside. Here, the image information is information including a gray level corresponding to each pixel unit, and an image signal such as a video signal is given as an example.

Note that the control portion may include the arithmetic portion and a memory portion which has stored a table in which illuminance, chromaticity, and the like of external light measured by the photometric portion, the gray level corresponding to the pixel unit, and the first and second gray levels are associated with one another. Here, in the arithmetic portion, the first and second gray levels corresponding to information input from the photometric portion and image information input from the outside are read from the table and output to the driver portion driving the first and second pixels.

A more specific example of one embodiment of the present invention is described below with reference to drawings.

### [Structure Example of Display Device]

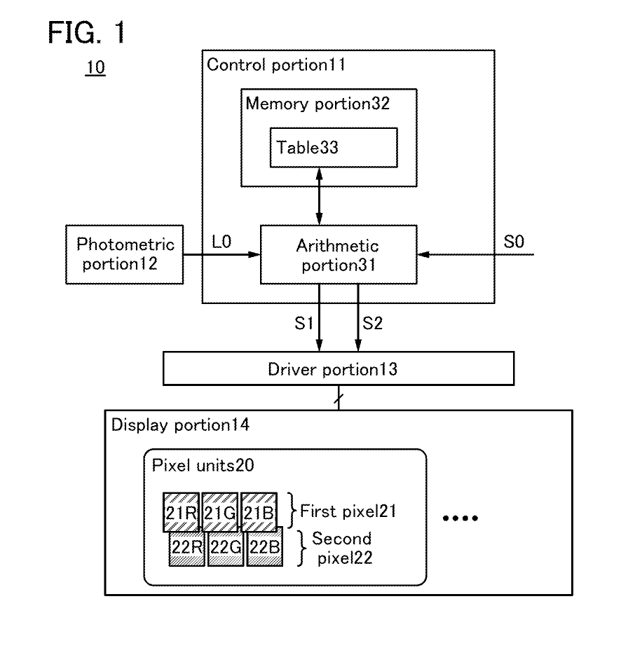

FIG. 1 is a block diagram of a display device 10 of one embodiment of the present invention. The display device 10 includes a control portion 11, a photometric portion 12, a driver portion 13, and a display portion 14.

The control portion 11 includes an arithmetic portion 31 and a memory portion 32. The memory portion 32 can store a table 33 as information.

The display portion 14 includes a plurality of pixel units 20 arranged in a matrix. The pixel unit 20 includes a first pixel 21 and a second pixel 22.

FIG. 1 shows an example where the first pixel 21 and the second pixel 22 each include display elements corresponding to three colors of red (R), green (G), and blue (B).

The first pixel 21 includes a display element 21R corresponding to red (R), a display element 21G corresponding to green (G), and a display element 21B corresponding to blue (B). The display elements 21R, 21G, and 21B each utilize reflection of external light.

The second pixel 22 includes a display element 22R corresponding to red (R), a display element 22G corresponding to green (G), and a display element 22B corresponding to blue (B). The display elements 22R, 22G, and 22B each utilize light of a light source.

The driver portion 13 includes a circuit for driving the plurality of pixel units 20 in the display portion 14. Specifically, the driver portion 13 supplies a signal including a gray level, a scan signal, a power supply potential, and the like to the first pixel 21 and the second pixel 22 included in the pixel unit 20. The driver portion 13 includes a signal line driver circuit and a scan line driver circuit, for example.

The photometric portion 12 can measure the illuminance of external light emitted to a display surface of the display portion 14 or its periphery. Furthermore, it is preferable that the photometric portion 12 can measure the chromaticity of external light in addition to the illuminance of the external light. The photometric portion 12 can output a signal L0 including the information of illuminance of external light and that of chromaticity of external light at the request of the arithmetic portion 31.

In the case where the photometric portion 12 measures only illuminance, a sensor which can measure the amount of light in a visible wavelength region can be used. For example, a sensor measuring the amount of light in part or all of a wavelength region from 300 nm to 750 nm can be used. For example, a sensor including a photodiode and a filter transmitting light in a wavelength region to be measured can be used.

In the case where the photometric portion 12 measures chromaticity, a sensor capable of measuring the amount of light of at least two or more colors can be used. For example, a sensor including three sensor elements detecting the amount of light of blue (a wavelength of greater than or equal to 450 nm and less than 500 nm), light of green (greater than or equal to 500 nm and less than 570 nm), and light of red (greater than or equal to 620 nm and less than or equal to 750 nm). The structure of the sensor is not limited thereto, one or more sensor elements detecting the amount of light of purple (greater than or equal to 380 nm and less than 450 nm), yellow (greater than or equal to 570 nm and less than 590 nm), and orange (greater than or equal to 590 nm and less than 620 nm) may be used instead of any one of the above three sensor elements or may be used in addition to the three sensor elements.

The photometric portion 12 may output an analog value corresponding to the amount of measured light as an analog signal to the arithmetic portion. Alternatively, it is preferable that the photometric portion 12 include an analog-digital converter circuit (ADC) so that an analog value is converted to a digital value and output to the arithmetic portion 31 as a digital signal.

It is important to arrange a detection surface of the photometric portion 12 in parallel to the display surface of the display portion 14. The photometric portion 12 is preferably provided as close to the display portion 14 as possible, and the distance between the photometric portion 12 and the display portion 14 may be less than or equal to 3 cm, preferably less than or equal to 2 cm, further preferably less than or equal to 1 cm, and greater than or equal to 100 μm, for example.

A video signal S0 including image information is input to the control portion 11 from the outside. The control portion 11 generates two signals (a signal S1 and a signal S2) including gray levels supplied to the pixel units 20 in the display portion 14 based on information of the illuminance and chromaticity of external light included in the signal L0 input from the photometric portion 12, and outputs the signals to the driver portion 13. The control portion 11 generates a timing signal such as a clock signal or a start pulse signal other than the signals S1 and S2 and outputs the signals to the driver portion 13.

The signal S1 includes a gray level supplied to the first pixel 21 in the pixel unit 20. Here, the signal S1 includes data of three gray levels supplied to the display elements 21R, 21G, and 21B per one pixel unit 20.

The signal S2 includes gray levels supplied to the second pixel 22 in the pixel unit 20. Here, the signal S2 includes data of three gray levels supplied to the display elements 22R, 22G, and 22B per one pixel unit 20.

The signals S1 and S2 each may be a serial signal transmitted through one signal line or a parallel signal transmitted through a plurality of signal lines.

FIG. 1 shows an example in which the control portion 11 includes the arithmetic portion 31 and the memory portion 32 storing the table 33. The table 33 includes information in which the illuminance of external light is associated with the first gray level supplied to the first pixel 21 and the second gray level supplied to the second pixel 22.

The arithmetic portion 31 can read out the first and second gray levels corresponding to information of the illuminance of external light input from the photometric portion 12 and the video signal S0 input from the outside from the table 33, generate the signal S1 including information of the first gray level and the signal S2 including information of the second gray level, and output the signals to the driver portion 13.

In the case where the photometric portion 12 can measure chromaticity, the table 33 includes information in which the illuminance and chromaticity of external light are associated with the first gray level supplied to the first pixel 21 and the second gray level supplied to the second pixel 22. Here, the arithmetic portion 31 can read out the first and second gray levels from the table 33 based on information of the illuminance and chromaticity of external light and the video signal S0, generate the signals S1 and S2, and output the signals to the driver portion 13.

Here, a microprocessor such as a graphics processing unit (GPU) can be used as the arithmetic portion 31, for example. Furthermore, such a microprocessor may be obtained with a programmable logic device (PLD) such as a field programmable gate array (FPGA) or a field programmable analog array (FPAA).

Here, the video signal S0 may be generated by a central processing unit (CPU) or the like provided separately from the display device 10 and supplied to the control portion 11. Alternatively, the arithmetic portion 31 may serve as a CPU and have a function of generating the video signal S0.

The video signal S0 input from the outside may be a signal that has already been subjected to gamma correction. The arithmetic portion 31 may have a function of performing the correction. The arithmetic portion 31 may generate the signals S1 and S2 based on a signal resulting from correction being performed on the video signal S0 or may correct each of generated signals S1 and S2.

The arithmetic operation unit 31 interprets and executes instructions from programs to process various kinds of data and control programs. The programs executed by the processor may be stored in a memory region of the processor or in the memory portion 32.

The arithmetic portion 31 may include a main memory. Alternatively, the memory portion 32 may be a main memory of the arithmetic portion 31. The main memory can include a volatile memory, such as a random access memory (RAM), and a nonvolatile memory, such as a read only memory (ROM).

For example, a dynamic random access memory (DRAM) is used for the RAM, in which case a memory space as a workspace for the arithmetic portion 31 is virtually allocated and used. An operating system, an application program, a program module, program data, and the like stored in the memory portion 32 or a memory device provided outside are loaded into the RAM and executed. The data, program, and program module which are loaded into the RAM are directly accessed and operated by the arithmetic portion 31. In the case where a main memory is provided separately from the memory portion 32 in the arithmetic portion 31, the table 33 may be read out from the memory portion 32 as a lookup table and stored in a main memory temporarily.

The control portion 11 may be mounted on a circuit board such as a printed circuit, and the driver portion 13 may be provided over a substrate over which the display portion 14 is formed. Here, the circuit board and the driver portion 13 are connected to each other via a flexible printed circuit (FPC) or the like. Furthermore, the driver portion 13 may be formed over a substrate over which the display portion 14 is formed through the same step as transistors and the like included in the display portion 14, and part or all of the driver portion 13 may be mounted on the substrate as an integrated circuit (IC). Alternatively, the control portion 11 and the driver portion 13 may be mounted on the substrate as one or more modes of IC. Alternatively, the control portion 11 and the driver portion 13 may be formed over a substrate over which the display portion 14 is formed through the same step as transistors included in the display portion 14.

That is the description of the structure examples of the display device.

### [Configuration Example of Pixel Unit]

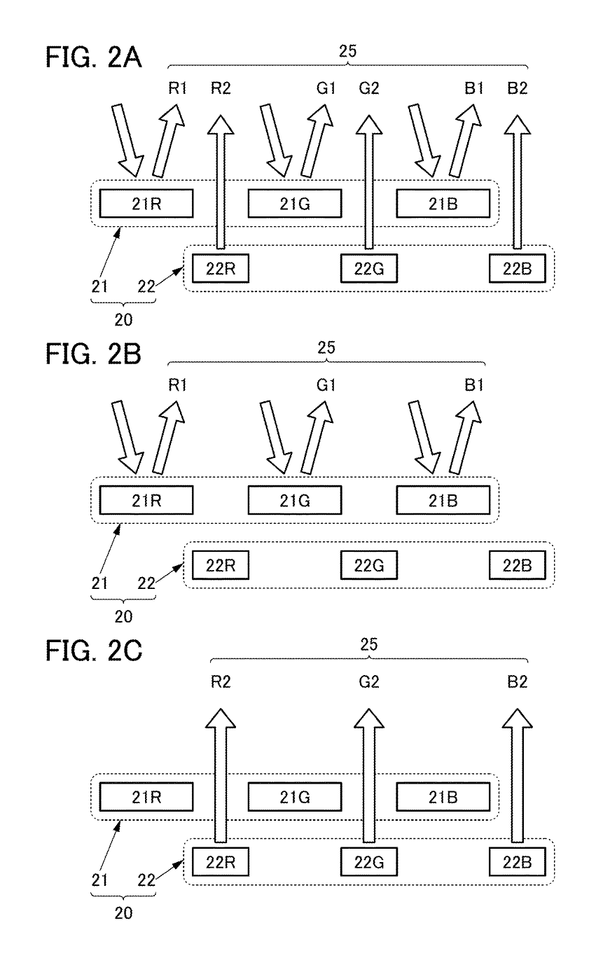

Next, the pixel unit 20 is explained with reference to FIGS. 2A to 2C. FIGS. 2A to 2C are schematic views illustrating structure examples of the pixel unit 20.

The first pixel 21 includes the display elements 21R, 21G, and 21B. The display element 21R reflects external light and emits to the display surface side red light R1 with a luminance in accordance with a gray level corresponding to a red color included in the first gray level input to the first pixel 21. The display element 21G and the display element 21B emit green light G1 and blue light B1, respectively, to the display surface side.

The second pixel 22 includes the display elements 22R, 22G, and 22B. The display element 22R includes a light source and emits to the display surface side red light R2 with a luminance in accordance with a gray level corresponding to a red color included in the second gray level input to the second pixel 22. The display element 22G and the display element 22B emit green light G2 and blue light B2, respectively, to the display surface side.

As illustrated in FIG. 2A, the pixel unit 20 can emit light 25 of a predetermined color to the display surface side by mixing light of six colors, the light R1, the light G1, the light B1, the light R2, the light G2, and the light B2.

Here, there are many combinations of light of six colors of the light R1, the light G1, the light B1, the light R2, the light G2, and the light B2, where the light 25 has predetermined luminance and chromaticity. Thus, in one embodiment of the present invention, a combination where the luminance (a gray level) of the light R1, the light G1, and the light B1 emitted from the first pixel 21 is largest is preferably selected from the combinations of light of six colors which realize the light 25 with the same luminance and chromaticity. Thus, power consumption can be reduced without impairing color reproducibility.

As illustrated in FIG. 2B, in the case where the illuminance of external light is sufficiently high, for example, the pixel unit 20 can emit the light 25 of a predetermined color by mixing only light from the first pixel 21 (the light R1, the light G1, and the light B1) without driving the second pixel 22. Thus, driving with extremely low power consumption can be performed.

As illustrated in FIG. 2C, in the case where the illuminance of external light is extremely low, for example, the pixel unit 20 can emit the light 25 of a predetermined color by mixing only light from the second pixel 22 (the light R2, the light G2, and the light B2) without driving the first pixel 21. Accordingly, a clear image can be displayed. Furthermore, luminance is lowered when the illuminance of external light is low, which can prevent a user from feeling glare and reduce power consumption.

The above is the description of the configuration example of the pixel unit 20.

### [Driving Method Example]

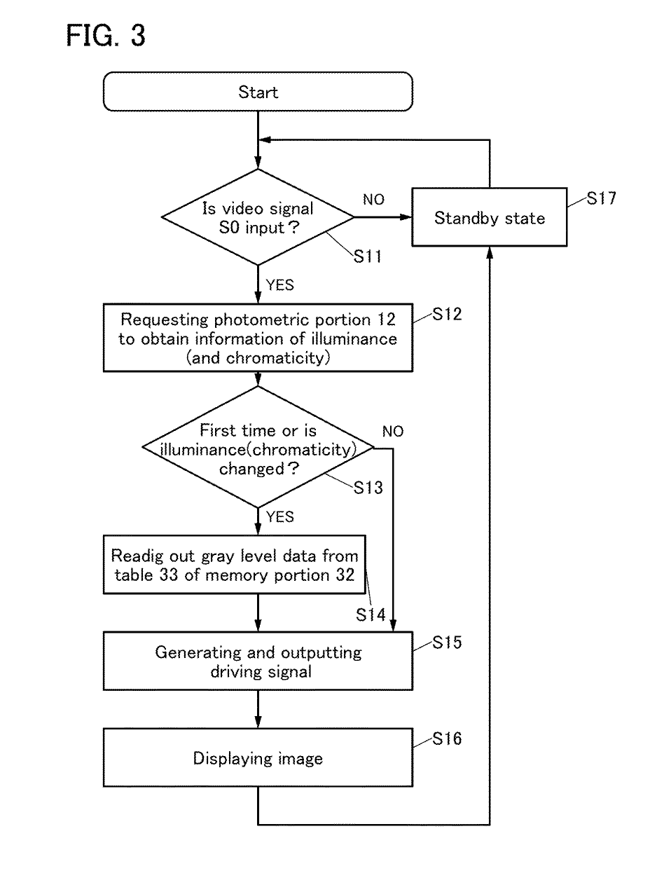

Hereinafter, an example of a method for driving the display device will be described. FIG. 3 is a flow chart showing the operation of the arithmetic portion 31 of the display device 10 illustrated in FIG. 1.

First, the arithmetic portion 31 determines whether the video signal S0 is input (S11).

When the video signal S0 is not input to the arithmetic portion 31, the operation proceeds to S17. In S17, the arithmetic portion 31 keeps in a standby state. In the standby state, the arithmetic portion 31 stops performing operation for displaying image until the video signal S0 is input to the arithmetic portion 31.

The operation proceeds to S12 when the video signal S0 is input to the arithmetic portion 31. In S12, the arithmetic portion 31 requests the photometric portion 12 to obtain information of the illuminance of external light or the illuminance and chromaticity of external light. The photometric portion 12 outputs the signal L0 including the information to the arithmetic portion 31 according to the instruction.

Next, the operation proceeds to S13. In S13, whether or not the signal L0 is input to the arithmetic portion 31 from the photometric portion 12 for the first time since the display operation has started is determined. Furthermore, in the case where the signal L0 is input for the second or subsequent time, whether or not the information of illuminance of external light or illuminance and chromaticity of external light is changed from the previous time is determined. In both the cases where the signal L0 is input from the photometric portion 12 for the first time and where the signal L0 is input for the second or subsequent time and the information of illuminance of external light or illuminance and chromaticity of external light is changed from the previous time, the operation proceeds to S14. In contrast, in the case where the information of illuminance of external light or illuminance and chromaticity of external light is not changed from the previous time, the operation proceeds to S15.

In S14, the arithmetic portion 31 reads out gray level data corresponding to the illuminance of external light or the illuminance and chromaticity of external light from the table 33 stored in the memory portion 32. The gray level data includes the first gray level corresponding to the first pixel 21 and the second gray level corresponding to the second pixel 22 which are associated with the gray level included in the input video signal S0.

In S15, the arithmetic portion 31 generates a driving signal output to the driver portion 13 on the basis of the video signal S0 and the gray level data that has been read out and outputs the driving signal to the driver portion 13. The driving signal includes a signal corresponding to the first gray level, a signal corresponding to the second gray level, the scan signal, the clock signal, the start pulse signal, and the like.

In the case where it is determined that the information of illuminance of external light or illuminance and chromaticity of external light is not changed from the previous time in S13, in S15, a driving signal output to the driver portion 13 is generated on the basis of the video signal S0 and the gray level data obtained in the previous time and is output to the driver portion 13.

In S16, signals are supplied to the pixel units 20 by the driver portion 13 and an image is displayed on the display portion 14. Then, the operation proceeds to S17.

Through the above operation, an image can be displayed on the display portion 14 of the display device 10.

The above is the description of an example of the driving method.

### [Modification Example]

An example of a method for driving a display device in which operation is partly different from that in the above driving method will be described below.

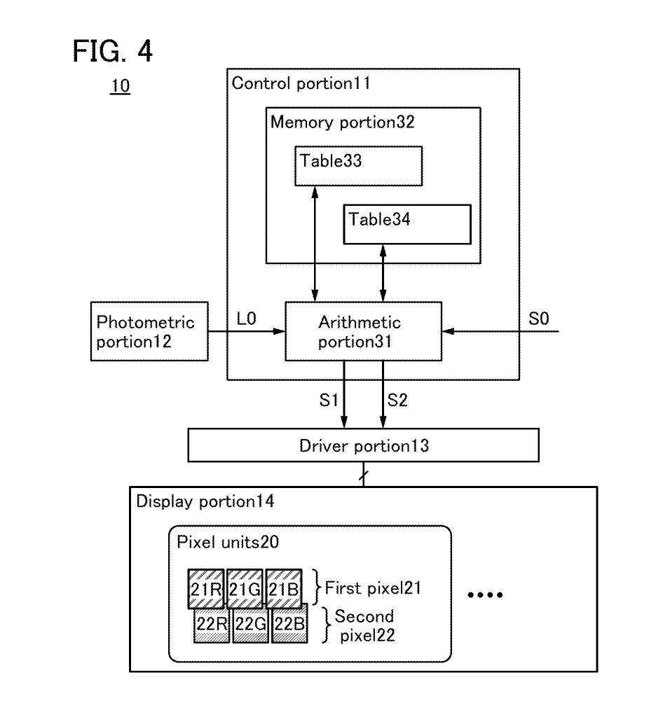

First, a structure example of the display device 10 to which a driving method described below can be applied is described with reference to FIG. 4. FIG. 4 is different from the structure illustrated in FIG. 1 in that the memory portion 32 stores a table 34 in addition to the table 33.

The table 34 stores information of video of a predetermined content. Furthermore, the table 34 includes data in which information of illuminance of external light or illuminance and chromaticity of external light and information of the signals S1 and S2 to be output to the driver portion 13 are associated with each other. Thus, the arithmetic portion 31 obtains information of the signals S1 and S2 from the table 34, whereby the information of the signals S1 and S2 can be directly output to the driver portion 13 without generating the signals. Therefore, the display device 10 can be driven with low power consumption as compared to the case where the signals S1 and S2 are generated because processing executed by the arithmetic portion 31 can be less in amount.

Here, the predetermined content includes an image or a video in a standby state, an image or a video in displaying the time, an image or a video displayed at the start-up or the shutdown of a device, and an image or a video displayed at the start-up or the shutdown of an application, for example. Furthermore, an image or a video which has been registered by a user in advance may be used as the predetermined content.

For example, the table 34 can be generated by calculating data on the signals S1 and S2 in advance with the arithmetic portion 31, an external arithmetic device, or the like on the basis of a video signal of the predetermined content and data stored in the table 33, and the table 34 can be stored in the memory portion 32 in advance.

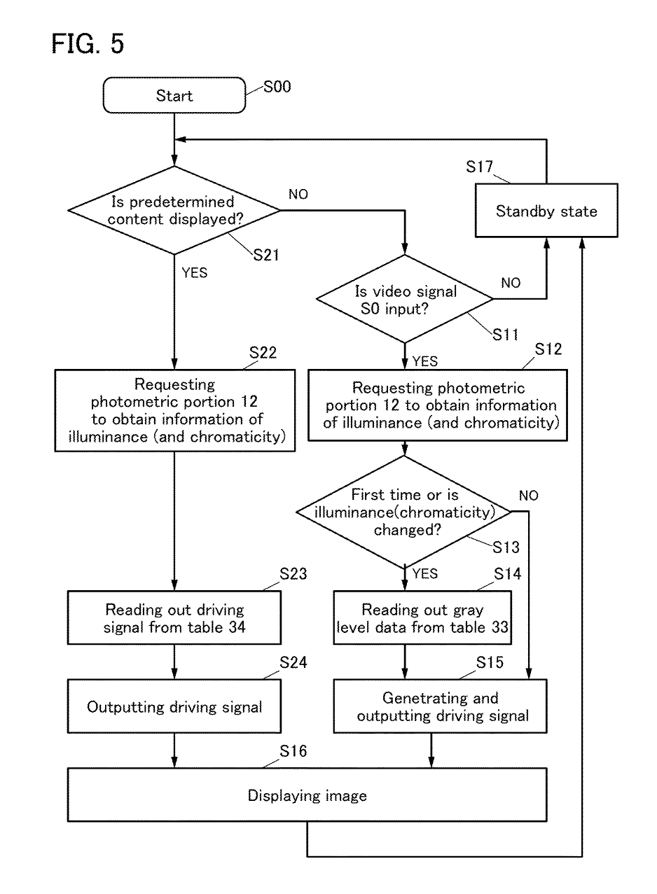

FIG. 5 shows a flow chart of an operation of the arithmetic portion 31. FIG. 5 is different from the flow chart shown in FIG. 3 mainly in that S21, S22, S23, and S24 are included. The detailed description of S11 to S17 in FIG. 5 is not repeated because the above example of the driving method can be referred to.

In S21, the arithmetic portion 31 determines whether a predetermined content or a video input from the outside should be displayed on the display portion 14. The operation proceeds to S22 in the case where the video is the predetermined content; the operation proceeds to S11 in the case where the video is the video input from the outside.

In the case where the predetermined content is determined to be displayed, in S22, the arithmetic portion 31 requests the photometric portion 12 to obtain information of illuminance of external light or illuminance and chromaticity of external light, and the signal L0 including the information is input from the photometric portion 12. Then, the operation proceeds to S23.

In S23, the arithmetic portion 31 reads out data of a driving signal corresponding to illuminance of external light or illuminance and chromaticity of external light from the table 34 stored in the memory portion 32. The data of the driving signal includes data of the signal corresponding to the first gray level and the signal corresponding to the second gray level. Furthermore, the data of the driving signal stored in the table 34 may include data of a scan signal, a clock signal, a start pulse signal, and the like. Alternatively, the arithmetic portion 31 may generate a scan signal, a clock signal, a start pulse signal, and the like separately.

Next, in S24, the arithmetic portion 31 outputs the driving signal to the driver portion 13. Then, in S16, signals are supplied to the pixel units 20 by the driver portion 13 and an image is displayed on the display portion 14. Then, the operation proceeds to S17.

In contrast, in S21, in the case where a video to be displayed on the display portion 14 is determined to be a video input from the outside, that is, a predetermined content is determined not to be displayed, an image can be displayed on the display portion 14 by driving in a manner similar to that in the above driving method example.

Through the above operation, display can be performed with extremely low power consumption in the case where the predetermined content is displayed. Since the processing executed by the arithmetic portion 31 is reduced, a video can be displayed at higher speed.

The above is the description of the modification example.

### [Example of Table]

An example of the table 33 which can be stored in the memory portion 32 is described below.

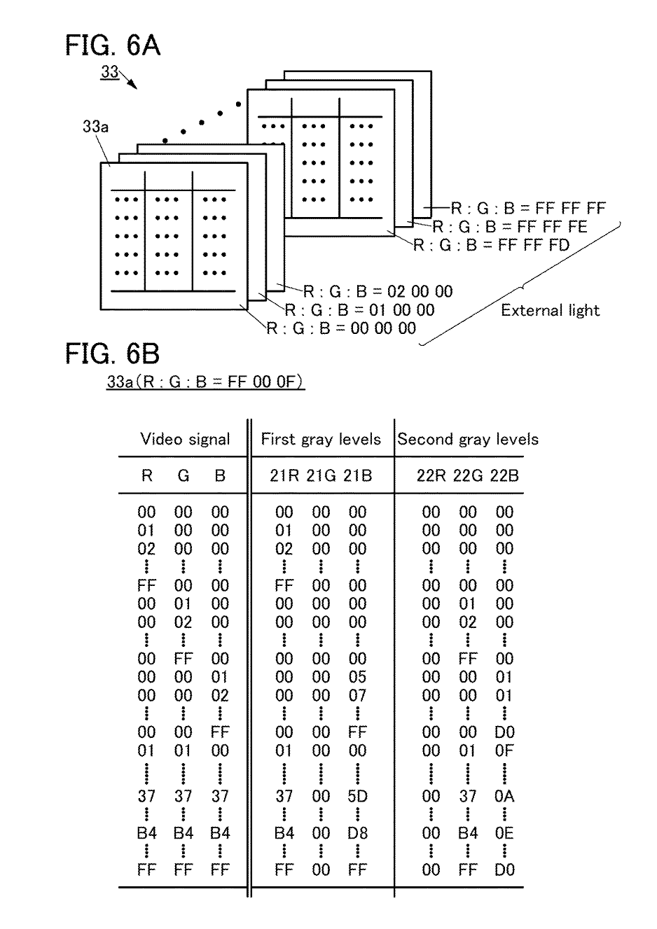

FIG. 6A schematically illustrates the table 33. The table 33 includes a plurality of data sheets 33a to which indexes (external light indexes) corresponding to the gray level data of external light included in the signal L0 output from the photometric portion 12 are assigned.

FIG. 6B schematically illustrates one data sheet 33a. The data sheet 33a includes indexes (video signal indexes) corresponding to gray level data included in the video signal S0 and tables of the first and second gray levels associated with the indexes. Here, the video signal index can also be referred to as gray level data of light to be output from the pixel unit 20.

In FIGS. 6A and 6B, each of the gray level of the video signal index, the gray level of the external light index, the first gray level, and the second gray level is 8 bits, and the gray levels are expressed by hexadecimal notation. Furthermore, each of the gray levels includes three data corresponding to red (R), green (G), and blue (B).

In FIG. 6B, an example of a data sheet in the case where the external light index is (R:G:B)=(FF 00 0F), that is, in the case where external light does not include a green wavelength component and a relatively low blue wavelength component is shown as an example of the data sheet 33a.

As shown in FIG. 6B, since red (R) light can be displayed by only the display element 21R owing to sufficiently high illuminance of external light, the gray level corresponding to the display element 22R is 00. Green (G) light needs to be displayed by only the display element 22G because light cannot obtained at all from the display element 21G, and thus the gray level corresponding to the display element 21G is 00. Blue (B) light with sufficient luminance cannot be obtained by only the display element 21B due to insufficient illuminance of external light, and thus blue (B) light is displayed by both the display elements 21B and 22B. Here, as shown in FIG. 6B, a gray level supplied to the display element 21B may be higher than a gray level of blue of the video signal.

In reality, the highest luminance in the maximum gray level (FF) of the display element 21R is different from the highest luminance in the maximum gray level (FF) of the display element 22R in some cases. Therefore, the values in the data sheet 33a are preferably determined in consideration of such a difference. The same applies to the display elements 21G and 22G and the display elements 21B and 22B.

When the arithmetic portion 31 reads out the first and second gray levels, a data sheet 33a which corresponds to a gray level included in the signal L0 input from the photometric portion 12 is selected. Next, the arithmetic portion 31 reads out the first and second gray levels corresponding to the gray level included in the video signal S0 from the selected data sheet 33a. Then, the arithmetic portion 31 can generate a driving signal on the basis of the first and second gray levels that have been read out and output the driving signal to the driver portion 13.

Here, the arithmetic portion 31 may read out a data sheet 33a corresponding to gray level of external light from the table 33 and store the data sheet 33a in the main memory. When the first and second gray levels corresponding to the gray level included in the video signal S0 are read out from the data sheet 33a stored in the main memory, processing speed can be increased.

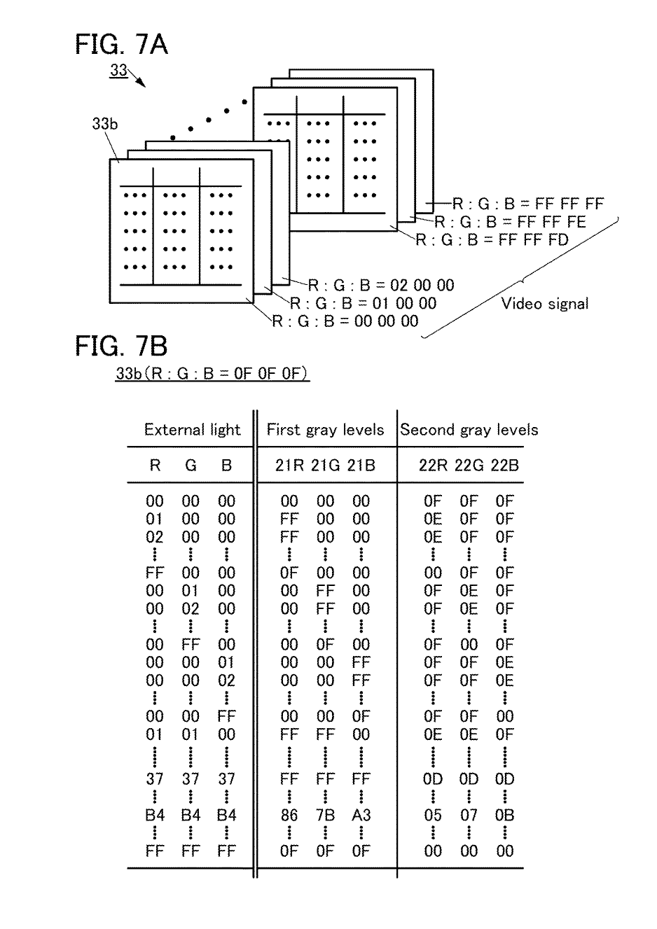

FIG. 7A shows an example of the table 33 different from that in FIG. 6A. The table 33 shown in FIGS. 7A includes a plurality of data sheets 33b to which video signal indexes are assigned.

As shown in FIG. 7B, the data sheet 33b includes an external light index and tables of the first gray level and second gray levels associated with the external light index. In FIG. 7B, a data sheet in the case where the video signal index is (R:G:B)=(0F 0F 0F) is shown as an example of the data sheet 33b.

When the arithmetic portion 31 reads out the first and second gray levels, a data sheet 33b which corresponds to a gray level included in the input video signal S0 is selected. Next, the arithmetic portion 31 reads out the first and second gray levels corresponding to the gray level of external light from the selected data sheet 33b on the basis of the input information of external light. Then, the arithmetic portion 31 can generate a driving signal to be output to the driver portion 13 on the basis of the first and second gray levels that have been read out and output the driving signal.

For simplicity, an example where the table 33 includes one data sheet 33a corresponding to the external light index or one data sheet 33b corresponding to the video signal index is described in the above description. The table 33 may include data in which the first and second gray levels associated with the video signal index and the external light index are arranged in a three-dimensional matrix.

Here, although an example where the table 33 includes data sheets 33a corresponding to all the gray levels of the external light index or the data sheets 33b corresponding to all the gray levels of the video signal index is shown, the amount of data may be reduced by removing some of the gray levels. Here, in the case where the video signal S0 or the signal L0 including a gray level which does not exist in a data sheet is input, the arithmetic portion 31 may calculate and use data which is compensated on the basis of data of the preceding and following data sheets.

Alternatively, one data sheet 33a or one data sheet 33b does not necessarily include data corresponding to all of the gray levels of the video signal index or the external light index, and the amount of data may be reduced by removing some of the gray levels. Here, in the case where the video signal S0 or the signal L0 including a gray level which does not exist in the video signal index or the external light index is input to the arithmetic portion 31, the arithmetic portion 31 may calculate and use data compensated based on the first and second gray levels corresponding to the preceding and following video signal indexes or external light indexes.

When some of the gray levels is removed, data or data sheets may be removed at regular intervals, the interval between data at which data is removed may be narrowed as the difference between adjacent data corresponding to gray levels in the index is larger. Alternatively, data is not necessarily removed.

When a table in which the data or data sheets are removed is used, for calculation which is performed by the arithmetic portion 31 to compensate data, linear interpolation, quadratic or more functions, or an exponential function may be used. Arithmetic formulas, coefficients, and the like which are used for the interpolation may be stored in the memory portion 32.

The above is the description of an example of the table.

### [Example of Method for Calculating Gray Level]

An example of a method for calculating the first gray level corresponding to the first pixel and the second gray level corresponding to the second pixel from information of gray level corresponding to the pixel unit 20 and illuminance and chromaticity of external light is described below.

### [Color Gamut]

First, the color gamut of each of the first pixel and the second pixel is described. Here, the color gamut that can be expressed by the first pixel 21 is referred to as a first color gamut C1. The color gamut that can be expressed by the second pixel 22 is referred to as a second color gamut C2.

### <xy Chromaticity Diagram>

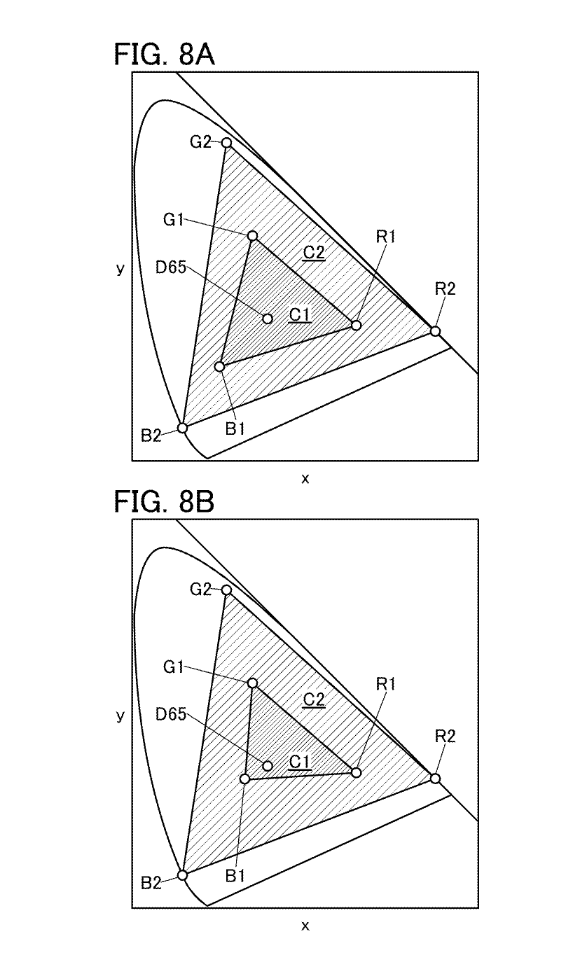

FIG. 8A shows an xy chromaticity diagram which shows an example of the first color gamut C1 and the second color gamut C2 under the specific external light. The first color gamut C1 of the first pixel 21 in the xy chromaticity diagram can be shown as a boundary and an inner region of a triangle formed by connecting three chromaticity coordinates of the light R1, the light G1, and the light B1 by straight lines. The light R1 can be emitted from the display element 21R. The light G1 can be emitted from the display element 21G. The light B1 can be emitted from the display element 21B. Similarly, the second color gamut C2 of the second pixel 22 is shown as a boundary and an inner region of a triangle formed by connecting chromaticity coordinates of the light R2, the light G2, and the light B2 by straight lines. In FIG. 8A, a point D65 corresponds to coordinates of white determined by the standard.

Since the second pixel 22 includes the display elements utilizing light of a light source and the first pixel 21 includes the display elements utilizing reflection of external light, the second color gamut C2 can be wider than the first color gamut C1. FIG. 8A shows an example where the first color gamut C1 is included inside the second color gamut C2.

The color gamut which can be expressed by the pixel unit 20 corresponds to the sum of the ranges of the first color gamut C1 and the second color gamut C2. In FIG. 8A, the second color gamut C2 corresponds to the color gamut which can be expressed by the pixel unit 20.

Here, the shape of the first color gamut C1 is changed by external light. For example, the case where luminance of light in a blue wavelength region in external light is lower than that of FIG. 8A is shown in FIG. 8B. At this time, the color gamut of the pixel unit 20 is not changed because the second color gamut C2 is not changed. That is, the display device of one embodiment of the present invention can have excellent color reproducibility regardless of change in external light.

### <XYZ Color Space>

As described above, the first color gamut C1 is changed by external light. Here, the intensity of light that can be emitted from the first pixel 21 is also changed by the illuminance of external light. Since information of luminance is not included in the xy chromaticity diagram, an XYZ color space is preferably used in the case where the color gamut including information of luminance is considered. Coordinates in XYZ coordinates of light represented as coordinates (x y) in the xy chromaticity diagram can be obtained by Formula 1. In the XYZ coordinates, light can be expressed as a vector with the origin as an initial point and the coordinates (X Y Z) as a terminal point.

[Formula 1]

X=x/y

Y=1.0

Z=(1−x−y)/y×Y (1)

Here, in the XYZ coordinates, light to be emitted from the pixel unit 20 is referred to as a vector A. Among light emitted from the first pixel 21, red light, green light, and blue light are represented as a vector R1, a vector G1, and a vector B1, respectively. Among light emitted from the second pixel 22, red light, green light, and blue light are represented as a vector R2, a vector G2, and a vector B2, respectively. The components of the vectors are shown in Formula 2.

[Formula 2]

\vec{A}=(a b c)

\vec{R1}=(R1ₓ R1_{y} R1_{z}) \vec{G1}=(G1ₓ G1_{y} G1_{z}) \vec{B1}=(B1ₓ B1_{y} B1_{z})

\vec{R2}=(R2ₓ R2_{y} R2_{z}) \vec{G2}=(G2ₓ G2_{y} G2_{z}) \vec{B2}=(B2ₓ B2_{y} B2_{z}) (2)

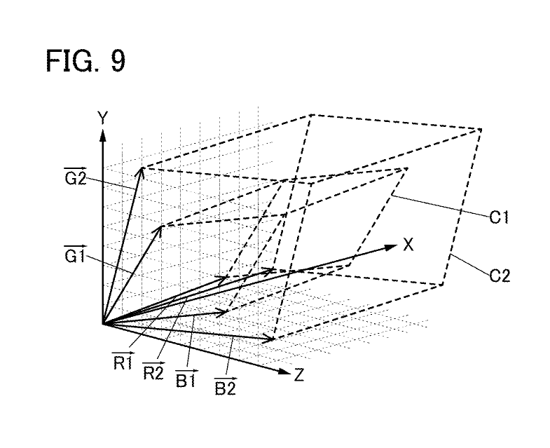

FIG. 9 shows an example where the first color gamut C1 and the second color gamut C2 under the specific external light are shown by the XYZ coordinates. The first color gamut C1 is expressed as a hexahedron which is formed by summing up the vector R1, the vector G1, and the vector B1. The second color gamut C2 is expressed as a hexahedron which is formed by summing up the vector R2, the vector G2, and the vector B2.

Since the vector components of the XYZ coordinates are different from gray levels represented by RGB, the vector components are required to be converted into RGB coordinates in order to calculate the gray levels. Light P (X Y Z) in the XYZ coordinates can be converted into RGB coordinates by Formula 3. The values of R, G, and B obtained here are normalized to obtain gray levels.

$$\begin{matrix}[ Formula 3 ] & \\ ( \begin{matrix}R \\ G \\ B\end{matrix} ) = M ( \begin{matrix}X \\ Y \\ Z\end{matrix} ) & ( 3 )\end{matrix}$$

In Formula 3, M is a determinant of three rows and three columns and is different depending on the standards of an RGB color space. The standards of the RGB color space include sRGB, NTSC, and Recommendation ITU-R BT.2020, for example.

### [Calculation of Gray Levels]

Light emitted from the pixel unit 20 is mixed light of light emitted from the first pixel 21 and light emitted from the second pixel 22. This means that, in the XYZ coordinates, the vector A of light emitted from the pixel unit 20 is represented by the sum of a vector A1 of light emitted from the first pixel 21 and a vector A2 of light emitted from the second pixel 22. That is, the vector A is divided into the vector A1 and the vector A2 and the gray levels of light corresponding to the vectors are obtained by using the conversion formula, whereby the first gray level supplied to the first pixel 21 and the second gray level supplied to the second pixel 22 can be calculated.

In one embodiment of the present invention, it is preferable that the gray level supplied to the first pixel be set to be as large as possible and the gray level supplied to the second pixel be set to be as small as possible. This corresponds to selecting a combination of the vectors A1 and A2 in which the absolute value of the vector A2 is minimized when the vector A is divided into the vector A1 and the vector A2.

Here, the calculation methods of the vectors A1 and A2 are largely classified into three cases according to the conditions of the vector A. The first case (Case 1) is the case where coordinates of the vector A are positioned inside the first color gamut C1. The second case (Case 2) is the case where the coordinates of the vector A are positioned inside the second color gamut C2 and outside the first color gamut C1, and the vector A intersects with the first color gamut C1 (i.e., passes through the first color gamut C1). The third case (Case 3) is the case where the coordinates of the vector A are positioned inside the second color gamut C2 and outside the first color gamut C1, and the vector A does not intersect with the first color gamut C1. A calculation method of each case is explained below.

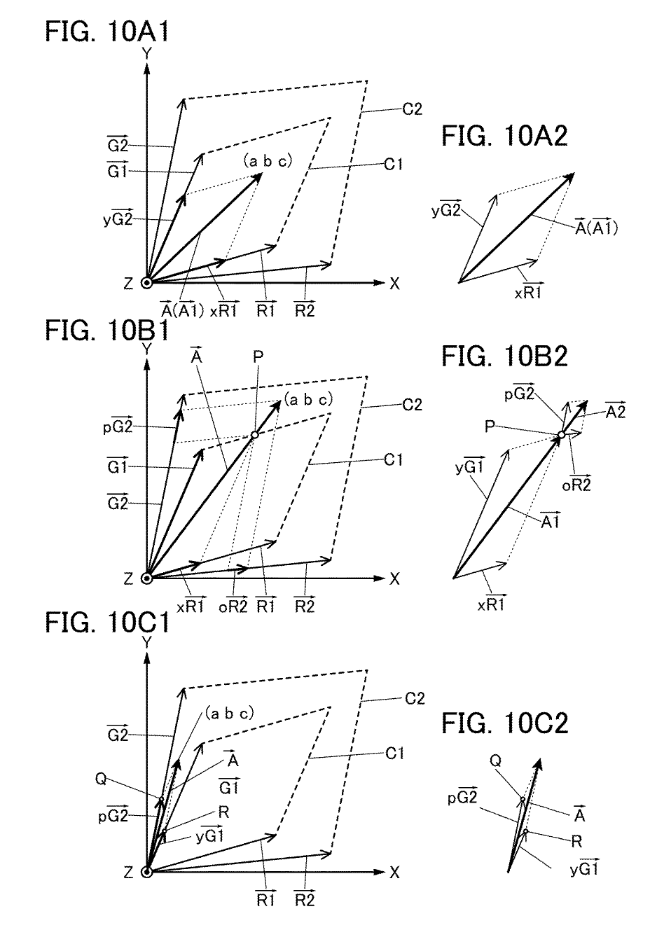

FIGS. 10A1, 10B1, and 10C1 are obtained by projecting the XYZ color space on the XY plane. Here, the vectors B1 and B2 are parallel to the Z direction for simplicity. In reality, the vectors B1 and B2 are not parallel to the Z direction and their X and Y components are greater than 0 as illustrated in FIG. 9.

### <Case 1>

FIG. 10A1 shows the case where the coordinates (a b c) of the vector A are positioned inside the first color gamut C1. Here, the vector A can be divided into three vectors parallel to the vectors R1, G1, and B1 of light emitted from the first pixel 21. That is, the vector A can be represented as only the vector A1 of light emitted from the first pixel 21.

FIG. 10A2 schematically shows the vector A which is extracted from FIG. 10A1. As shown in FIG. 10A2, the vector A can be divided into a vector which is x times the vector R1 (x is greater than or equal to 0 and less than or equal to 1), a vector which is y times the vector G1 (y is greater than or equal to 0and less than or equal to 1), and a vector which is z times the vector B1 (not illustrated) (z is greater than or equal to 0 and less than or equal to 1).

As described above, in the case where light emitted from the pixel unit 20 can be expressed by only the first pixel 21, display can be performed by driving only the first pixel 21 without driving the second pixel 22. Therefore, power consumption can be reduced because the second pixel 22 including a light source is not driven.

### <Case 2>

In FIG. 10B1, the coordinates (a b c) of the vector A are positioned inside the second color gamut C2 and outside the first the color gamut C1. Furthermore, the vector A intersects with the first color gamut C1 (i.e., passes through the first color gamut C1). Here, a point P is a point of an intersection of the vector A with the boundary of the first color gamut C1.

As illustrated in FIG. 10B2, the vector A can be divided into the vector A1 and the vector A2. Here, the vector A1 is a vector with the origin as an initial point and the point P as a terminal point, and the vector A2 is a vector with the point P as an initial point and a terminal point of the vector A as a terminal point.

The vector A1 can be divided into a vector which is x times the vector R1, a vector which is y times the vector G1, and a vector which is z times the vector B1 (not illustrated).

The vector A2 can be divided into a vector which is o times the vector R2 (o is greater than or equal to 0 and less than or equal to 1), a vector which is p times the vector G2 (p is greater than or equal to 0 and less than or equal to 1), and a vector which is q times the vector B2 (not illustrated) (q is greater than or equal to 0 and less than or equal to 1).

In this manner, the absolute value of the vector A1 can be maximized. That is, the first gray level supplied to the first pixel 21 can be maximized.

In this manner, light emitted from the pixel unit 20 is expressed by both light emitted from the first pixel 21 and light emitted from the second pixel 22, whereby power consumption can be reduced. Furthermore, the first gray level supplied to the first pixel is maximized, whereby power consumption can be reduced more effectively.

### <Case 3>

In FIG. 10C1, the coordinates (a b c) of the vector A are positioned inside the second color gamut C2 and outside the first the color gamut C1. Furthermore, the vector A does not intersect with the first color gamut C1.

FIG. 10C1 shows the case where the vector A is positioned between the vector G1 and the vector G2. Specifically, the coordinates (a b c) of the vector A are positioned between a plane formed by the vector G1 and the vector B1 and a plane formed by the vector G2 and the vector B2, and the vector A and the two planes are in contact with each other at the origin. Although FIG. 10C1 shows the case where both the vectors B1 and B2 are parallel to the Z axis, the same also applies to the case where the vectors B1 and B2 are tilted from the Z axis.

Here, as illustrated in FIG. 10C2, the vector A can be divided into a vector which is y times the vector G1, a vector which is z times the vector B1 (not illustrated), a vector which is p times the vector G2, and a vector which is q times the vector B2 (not illustrated). That is, the vector A can be divided into four vectors without using the vectors R1 and R2.

For example, in an XY plane, a point Q is an intersection of the vector G2 and a straight line which passes through the coordinates (a b) of the vector A and is parallel to the vector G1, and a point R is an intersection of the vector G1 and a straight line which passes through the coordinates (a b) and is parallel to the vector G2. Here, the vector A can be divided into a vector with the origin as an initial point and the point Q as a terminal point and a vector with the origin as an initial point and the point R as a terminal point. In the case of developing the vector A to the XYZ space, the vector A can be divided into four vectors by applying the above method.

In the case where coordinates of the terminal point of the vector A are positioned between a plane formed by the vectors R1 and B1 and a plane formed between the vectors R2 and B2, the vector A can be divided into four vectors respectively parallel to the four vectors except the vectors G1 and G2.

Similarly, in the case where the coordinates of the terminal point of the vector A are positioned between a plane formed by the vectors R1 and G1 and a plane formed by the vectors R2 and G2, the vector A can be divided into four vectors respectively parallel to the four vectors except the vectors B1 and B2.

In this manner, even in the case where light emitted from the pixel unit 20 is out of the color gamut C1 which can be expressed by the first pixel 21, power consumption can be reduced by partly using light of the first pixel 21 as compared to the case where only the second pixel 22 is driven.

Thus, in all three Cases 1 to 3, the vector A of light to be emitted from the pixel unit 20 can be divided into the vector A1 of light emitted from the first pixel 21 and the vector A2 of light emitted from the second pixel 22. Then, the gray levels of light corresponding to the two vectors obtained here are calculated by using the above conversion formula, whereby the first gray level supplied to the first pixel 21 and the second gray level supplied to the second pixel 22 can be calculated.

Since the color gamut C1 changes in accordance with the luminance and chromaticity of external light, the first and second gray levels under various expected conditions of external light (e.g., the value of the external light index shown in FIGS. 6A and 6B or the like) are calculated. Then, the table 33 stored in the memory portion 32 is formed based on the calculated data.

The above is the description of the example of the calculation method of the gray levels.

At least part of this embodiment can be implemented in combination with any of the other embodiments and the other examples described in this specification as appropriate.

### Embodiment 2

An example of a display panel which can be used for a display portion or the like in the display device of one embodiment of the present invention is described below. The display panel described below as an example includes both a reflective liquid crystal element and a light-emitting element and can display an image in both the transmissive mode and the reflective mode.

### [Structure Example]

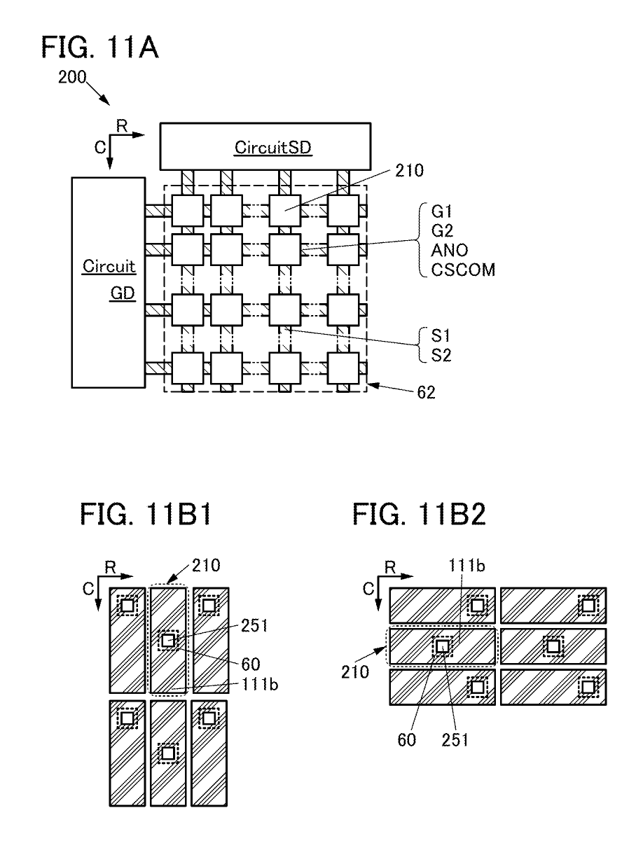

FIG. 11A is a block diagram illustrating an example of the structure of a display panel 200. The display panel 200 includes a plurality of pixels 210 which are arranged in a matrix in the display portion 62. The display panel 200 also includes a circuit GD and a circuit SD. The display panel 200 includes a plurality of wirings G1, a plurality of wirings G2, a plurality of wirings ANO, and a plurality of wirings CSCOM, which are electrically connected to the circuit GD and the plurality of pixels 210 arranged in a direction R. The display device 200 includes a plurality of wirings 51 and a plurality of wirings S2, which are electrically connected to the circuit SD and the plurality of pixels 210 arranged in a direction C.

The pixel 210 includes a reflective liquid crystal element and a light-emitting element. In the pixel 210, the liquid crystal element and the light emitting element partly overlap with each other.

FIG. 11B1 illustrates a structure example of a conductive layer 111b included in the pixel 210. The conductive layer 111b serves as a reflective electrode of the liquid crystal element in the pixel 210. The conductive layer 111b includes an opening 251.

In FIG. 11B1, the light-emitting element 60 in a region overlapping with the conductive layer 111b is denoted by a dashed line. The light-emitting element 60 overlaps with the opening 251 included in the conductive layer 111b. Thus, light from the light-emitting element 60 is emitted to a display surface side through the opening 251.

In FIG. 11B1, the pixels 210 adjacent in the direction R correspond to different colors. As illustrated in FIG. 11B1, the openings 251 are preferably provided in different positions in the conductive layers 111b so as not to be aligned in the two pixels adjacent to each other in the direction R. This allows the two light-emitting elements 60 to be apart from each other, thereby preventing light emitted from the light-emitting element 60 from entering a coloring layer in the adjacent pixel 210 (such a phenomenon is also referred to as crosstalk). Furthermore, since the two adjacent light-emitting elements 60 can be arranged apart from each other, a high-resolution display panel is achieved even when EL layers of the light-emitting elements 60 are separately formed with a shadow mask or the like.

Alternatively, arrangement illustrated in FIG. 11B2 may be employed.

If the ratio of the total area of the opening 251 to the total area except for the opening is too large, display performed using the liquid crystal element is dark. If the ratio of the total area of the opening 251 to the total area except for the opening is too small, display performed using the light-emitting element 60 is dark.

If the area of the opening 251 in the conductive layer 111b serving as a reflective electrode is too small, light emitted from the light-emitting element 60 is not efficiently extracted for display.

The opening 251 may have a polygonal shape, a quadrangular shape, an elliptical shape, a circular shape, a cross-like shape, a stripe shape, a slit-like shape, or a checkered pattern, for example. The opening 251 may be close to the adjacent pixel. Preferably, the opening 251 is provided close to another pixel emitting light of the same color, in which case crosstalk can be suppressed.

### [Circuit Structure Example]

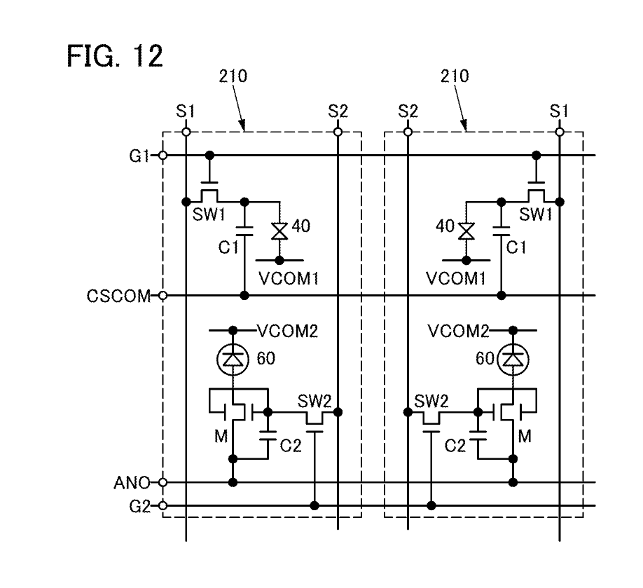

FIG. 12 is a circuit diagram illustrating a structure example of the pixel 210. FIG. 12 shows two adjacent pixels 210.

The pixel 210 includes a switch SW1, a capacitor C1, the liquid crystal element 40, a switch SW2, a transistor M, a capacitor C2, the light-emitting element 60, and the like. The pixel 210 is electrically connected to the wiring G1, the wiring G2, the wiring ANO, the wiring CSCOM, the wiring S1, and the wiring S2. FIG. 12 also illustrates a wiring VCOM1 electrically connected to the liquid crystal element 40 and a wiring VCOM2 electrically connected to the light-emitting element 60.

FIG. 12 illustrates an example in which a transistor is used as each of the switches SW1 and SW2.

A gate of the switch SW1 is connected to the wiring G1. One of a source and a drain of the switch SW1 is connected to the wiring S1, and the other of the source and the drain is connected to one electrode of the capacitor C1 and one electrode of the liquid crystal element 40. The other electrode of the capacitor C1 is connected to the wiring CSCOM. The other electrode of the liquid crystal element 40 is connected to the wiring VCOM1.

A gate of the switch SW2 is connected to the wiring G2. One of a source and a drain of the switch SW2 is connected to the wiring S2, and the other of the source and the drain is connected to one electrode of the capacitor C2 and a gate of the transistor M. The other electrode of the capacitor C2 is connected to one of a source and a drain of the transistor M and the wiring ANO. The other of the source and the drain of the transistor M is connected to one electrode of the light-emitting element 60. The other electrode of the light-emitting element 60 is connected to the wiring VCOM2.

FIG. 12 illustrates an example in which the transistor M includes two gates between which a semiconductor is provided and which are connected to each other. This structure can increase the amount of current flowing through the transistor M.

The wiring G1 can be supplied with a signal for changing the on/off state of the transistor SW1. A predetermined potential can be supplied to the wiring VCOM1. The wiring S1 can be supplied with a signal for changing the orientation of liquid crystals of the liquid crystal element 40. A predetermined potential can be supplied to the wiring CSCOM.

The wiring G2 can be supplied with a signal for changing the on/off state of the transistor SW2. The wiring VCOM2 and the wiring ANO can be supplied with potentials having a difference large enough to make the light-emitting element 60 emit light. The wiring S2 can be supplied with a signal for changing the on/off state of the transistor M.

In the pixel 210 of FIG. 12, for example, an image can be displayed in the reflective mode by driving the pixel with the signals supplied to the wiring G1 and the wiring S1 and utilizing the optical modulation of the liquid crystal element 40. In the case where an image is displayed in the transmissive mode, the pixel is driven with the signals supplied to the wiring G2 and the wiring S2 and the light-emitting element 60 emits light. In the case where both modes are performed at the same time, the pixel can be driven with the signals to the wiring G1, the wiring G2, the wiring S1, and the wiring S2.

### [Structure Example of Display Panel]

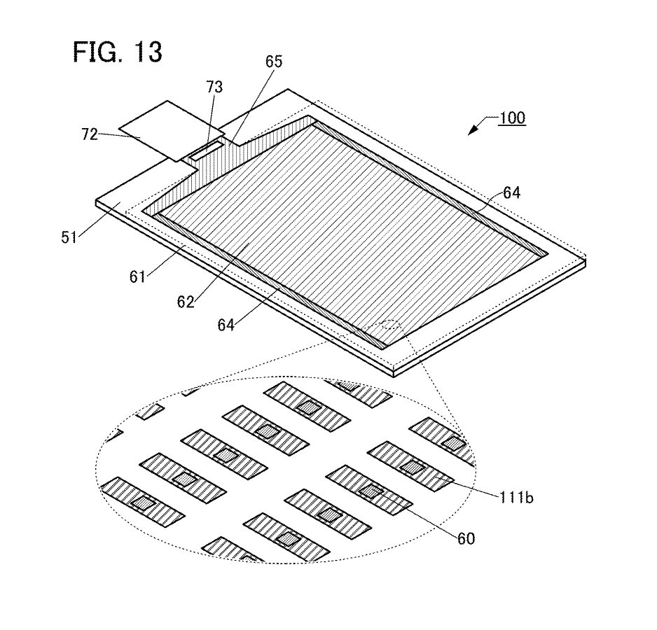

FIG. 13 is a schematic perspective view illustrating a display panel 100 of one embodiment of the present invention. In the display panel 100, a substrate 51 and a substrate 61 are attached to each other. In FIG. 13, the substrate 61 is denoted by a dashed line.

The display panel 100 includes a display portion 62, a circuit 64, a wiring 65, and the like. The substrate 51 is provided with the circuit 64, the wiring 65, a conductive layer 111b which serves as a pixel electrode, and the like. In FIG. 13, an IC 73 and an FPC 72 are mounted on the substrate 51. Thus, the structure illustrated in FIG. 13 can be referred to as a display module including the display panel 100, the FPC 72, and the IC 73.

As the circuit 64, for example, a circuit functioning as a scan line driver circuit can be used.

The wiring 65 has a function of supplying a signal or electric power to the display portion 62 or the circuit 64. The signal or electric power is input to the wiring 65 from the outside through the FPC 72 or from the IC 73.

FIG. 13 shows an example in which the IC 73 is provided on the substrate 51 by a chip on glass (COG) method or the like. As the IC 73, an IC functioning as a scan line driver circuit, a signal line driver circuit, or the like can be used. Note that it is possible that the IC 73 is not provided when, for example, the display panel 100 includes circuits serving as a scan line driver circuit and a signal line driver circuit and when the circuits serving as a scan line driver circuit and a signal line driver circuit are provided outside and a signal for driving the display panel 100 is input through the FPC 72. Alternatively, the IC 73 may be mounted on the FPC 72 by a chip on film (COF) method or the like.

FIG. 13 also shows an enlarged view of part of the display portion 62. The conductive layers 111b included in a plurality of display elements are arranged in a matrix in the display portion 62. The conductive layer 111b has a function of reflecting visible light and serves as a reflective electrode of the liquid crystal element 40 described later.

As illustrated in FIG. 13, the conductive layer 111b has an opening. The light-emitting element 60 is provided on the substrate 51 side of the conductor 111b. Light is emitted from the light-emitting element 60 to the substrate 61 side through the opening in the conductive layer 111b.

### [Cross-Sectional Structure Examples]

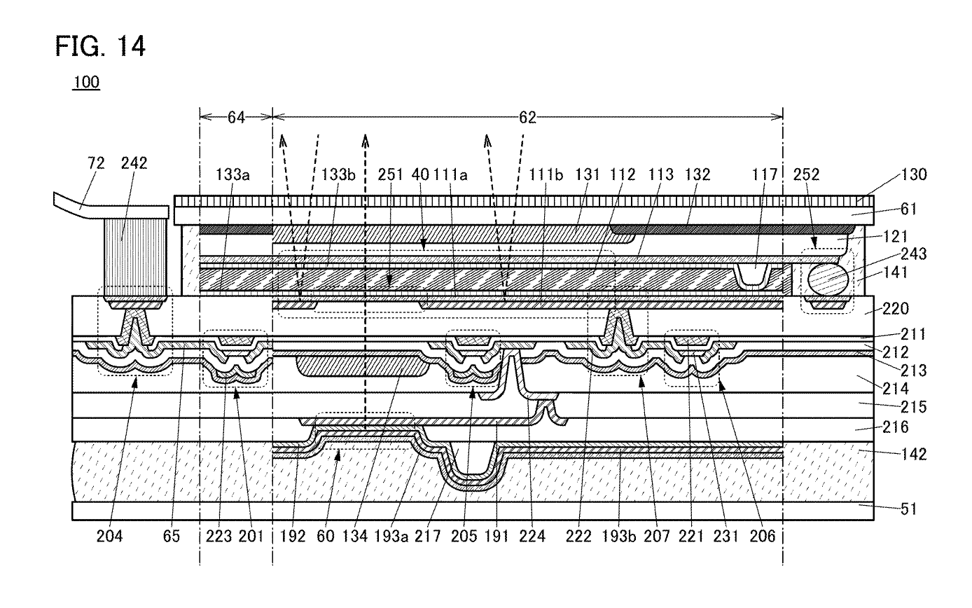

FIG. 14 shows an example of cross sections of part of a region including the FPC 72, part of a region including the circuit 64, and part of a region including the display region 62 of the display panel illustrated in FIG. 13.

The display panel includes an insulating layer 220 between the substrates 51 and 61. The display panel also includes the light-emitting element 60, a transistor 201, a transistor 205, a transistor 206, a coloring layer 134, and the like between the substrate 51 and the insulating layer 220. Furthermore, the display panel includes the liquid crystal element 40, the coloring layer 131 and the like between the insulating layer 220 and the substrate 61. The substrate 61 and the insulating layer 220 are bonded with the adhesive layer 141. The substrate 51 and the insulating layer 220 are bonded with an adhesive layer 142.

The transistor 206 is electrically connected to the liquid crystal element 40 and the transistor 205 is electrically connected to the light-emitting element 60. Since the transistors 205 and 206 are formed on a surface of the insulating layer 220 which is on the substrate 51 side, the transistors 205 and 206 can be formed through the same process.

The coloring layer 131, a light-blocking layer 132, an insulating layer 121, and a conductive layer 113 serving as a common electrode of the liquid crystal element 40, an alignment film 133b, an insulating layer 117, and the like are provided over the substrate 61. The insulating layer 117 serves as a spacer for holding a cell gap of the liquid crystal element 40.

Insulating layers such as an insulating layer 211, an insulating layer 212, an insulating layer 213, an insulating layer 214, an insulating layer 215, and the like are provided on the substrate 51 side of the insulating layer 220. Part of the insulating layer 211 functions as a gate insulating layer of each transistor. The insulating layer 212, the insulating layer 213, and the insulating layer 214 are provided to cover each transistor and the like. The insulating layer 215 is provided to cover the insulating layer 214. The insulating layers 214 and 215 each function as a planarization layer. Note that an example where the three insulating layers, the insulating layers 212, 213, and 214, are provided to cover the transistors and the like is described here; however, one embodiment of the present invention is not limited to this example, and four or more insulating layers, a single insulating layer, or two insulating layers may be provided. The insulating layer 214 functioning as a planarization layer is not necessarily provided when not needed.

The transistors 201, 205, and 206 each include a conductive layer 221 part of which functions as a gate, conductive layers 222 part of which functions as a source and a drain, and a semiconductor layer 231. Here, a plurality of layers obtained by processing the same conductive film are shown with the same hatching pattern.

The liquid crystal element 40 is a reflective liquid crystal element. The liquid crystal element 40 has a stacked structure of a conductive layer 111a, liquid crystal 112, and a conductive layer 113. A conductive layer 111b which reflects visible light is provided in contact with the surface of the conductive layer 111a that faces the substrate 51. The conductive layer 111b includes an opening 251. The conductive layers 111a and 113 contain a material transmitting visible light. In addition, an alignment film 133a is provided between the liquid crystal 112 and the conductive layer 111a and an alignment film 133b is provided between the liquid crystal 112 and the conductive layer 113. A polarizing plate 130 is provided on an outer surface of the substrate 61.

In the liquid crystal element 40, the conductive layer 111b has a function of reflecting visible light, and the conductive layer 113 has a function of transmitting visible light. Light entered from the substrate 61 side is polarized by the polarizing plate 130, passes through the conductive layer 113 and the liquid crystal 112, and is reflected by the conductive layer 111b. Then, the light passes through the liquid crystal 112 and the conductive layer 113 again and reaches the polarizing plate 130. In this case, alignment of the liquid crystal 112 is controlled with a voltage that is applied between the conductive layer 111b and the conductive layer 113, and thus optical modulation of light can be controlled. That is, the intensity of light emitted through the polarizing plate 130 can be controlled. Light other than one in a particular wavelength region of the light is absorbed by the coloring layer 131, and thus, emitted light is red light, for example.

The light-emitting element 60 is a bottom-emission light-emitting element. The light-emitting element 60 has a structure in which a conductive layer 191, an EL layer 192, and a conductive layer 193b are stacked in this order from the insulating layer 220 side. In addition, a conductive layer 193a is provided to cover the conductive layer 193b. The conductive layer 193b contains a material reflecting visible light, and the conductive layers 191 and 193a contain a material transmitting visible light. Light is emitted from the light-emitting element 60 to the substrate 61 side through the coloring layer 134, the insulating layer 220, the opening 251, the conductive layer 113, and the like.

Here, as illustrated in FIG. 14, the conductive layer 111a transmitting visible light is preferably provided for the opening 251. Accordingly, the liquid crystal 112 is aligned in a region overlapping with the opening 251 as well as in the other regions, in which case an alignment defect of the liquid crystal is prevented from being generated in the boundary portion of these regions and undesired light leakage can be suppressed.

As the polarizing plate 130 provided on an outer surface of the substrate 61, a linear polarizing plate or a circularly polarizing plate can be used. An example of a circularly polarizing plate is a stack including a linear polarizing plate and a quarter-wave retardation plate. Such a structure can reduce reflection of external light. The cell gap, alignment, drive voltage, and the like of the liquid crystal element used as the liquid crystal element 40 are controlled depending on the kind of the polarizing plate so that desirable contrast is obtained.

An insulating layer 217 is provided on the insulating layer 216 covering an end portion of the conductive layer 191. The insulating layer 217 has a function as a spacer for preventing the insulating layer 220 and the substrate 51 from getting closer more than necessary. In addition, in the case where the EL layer 192 or the conductive layer 193a is formed using a blocking mask (metal mask), the insulating layer 217 may have a function of preventing the blocking mask from being in contact with a surface on which the EL layer 192 or the conductive layer 193a is formed. Note that the insulating layer 217 is not necessarily provided.

One of a source and a drain of the transistor 205 is electrically connected to the conductive layer 191 of the light-emitting element 60 through a conductive layer 224.

One of a source and a drain of the transistor 206 is electrically connected to the conductive layer 111b through a connection portion 207. The conductive layers 111b and 111a are in contact with and electrically connected to each other. Here, in the connection portion 207, the conductive layers provided on both surfaces of the insulating layer 220 are connected to each other through openings in the insulating layer 220.

The connection portion 204 is provided in a region where the substrates 51 and 61 do not overlap with each other. The connection portion 204 has a structure similar to that of the connection portion 207. On the top surface of the connection portion 204, a conductive layer obtained by processing the same conductive film as the conductive layer 111a is exposed. Thus, the connection portion 204 and the FPC 72 can be electrically connected to each other through the connection layer 242.

A connection portion 252 is provided in part of a region where the adhesive layer 141 is provided. In the connection portion 252, the conductive layer obtained by processing the same conductive film as the conductive layer 111a is electrically connected to part of the conductive layer 113 with a connector 243. Accordingly, a signal or a potential input from the FPC 72 connected to the substrate 51 side can be supplied to the conductive layer 113 formed on the substrate 61 side through the connection portion 252.

As the connector 243, a conductive particle can be used, for example. As the conductive particle, a particle of an organic resin, silica, or the like coated with a metal material can be used. It is preferable to use nickel or gold as the metal material because contact resistance can be decreased. It is also preferable to use a particle coated with layers of two or more kinds of metal materials, such as a particle coated with nickel and further with gold. As the connector 243, a material capable of elastic deformation or plastic deformation is preferably used. As illustrated in FIG. 14, the connector 243 which is the conductive particle has a shape that is vertically crushed in some cases. With the crushed shape, the contact area between the connector 243 and a conductive layer electrically connected to the connector 243 can be increased, thereby reducing contact resistance and suppressing the generation of problems such as disconnection.

The connector 243 is preferably provided so as to be covered with the adhesive layer 141. For example, a paste or the like for forming the adhesive layer 141 may be applied, and then, the connector 243 may be provided.

FIG. 14 illustrates an example of the circuit 64 in which the transistor 201 is provided.

The structure in which the semiconductor layer 231 where a channel is formed is provided between two gates is used as an example of the transistors 201 and 205 in FIG. 14. One gate is formed by the conductive layer 221 and the other gate is formed by a conductive layer 223 overlapping with the semiconductor layer 231 with the insulating layer 212 provided therebetween. Such a structure enables control of threshold voltages of transistors. In that case, the two gate electrodes may be connected to each other and supplied with the same signal to operate the transistors. Such transistors can have higher field-effect mobility and thus have higher on-state current than other transistors. Consequently, a circuit capable of high-speed operation can be obtained. Furthermore, the area occupied by a circuit portion can be reduced. The use of the transistor having high on-state current can reduce signal delay in wirings and can reduce display unevenness even in a display panel in which the number of wirings is increased because of increase in size or definition.

Note that the transistor included in the circuit 64 and the transistor included in the display portion 62 may have the same structure. A plurality of transistors included in the circuit 64 may have the same structure or different structures. A plurality of transistors included in the display portion 62 may have the same structure or different structures.

A material through which impurities such as water or hydrogen do not easily diffuse is preferably used for at least one of the insulating layers 212 and 213 which cover the transistors. That is, the insulating layer 212 or the insulating layer 213 can function as a barrier film. Such a structure can effectively suppress diffusion of the impurities into the transistors from the outside, and a highly reliable display panel can be provided.

The insulating layer 121 is provided on the substrate 61 side to cover the coloring layer 131 and the light-blocking layer 132. The insulating layer 121 may have a function of a planarization layer. The insulating layer 121 enables the conductive layer 113 to have an almost flat surface, resulting in a uniform alignment state of the liquid crystal 112.

An example of the method for manufacturing the display panel 100 is described. For example, the conductive layer 111a, the conductive layer 111b, and the insulating layer 220 are formed in order over a support substrate provided with a separation layer, and the transistor 205, the transistor 206, the light-emitting element 60, and the like are formed. Then, the substrate 51 and the support substrate are bonded with the adhesive layer 142. After that, separation is performed at the interface between the separation layer and each of the insulating layer 220 and the conductive layer 111a, whereby the support substrate and the separation layer are removed. Separately, the coloring layer 131, the light-blocking layer 132, the conductive layer 113, and the like are formed over the substrate 61 in advance. Then, the liquid crystal 112 is dropped onto the substrate 51 or 61 and the substrates 51 and 61 are bonded with the adhesive layer 141, whereby the display panel 100 can be manufactured.

A material for the separation layer can be selected such that separation at the interface with the insulating layer 220 and the conductive layer 111a occurs. In particular, it is preferable that a stacked layer of a layer including a high-melting-point metal material, such as tungsten, and a layer including an oxide of the metal material be used as the separation layer, and a stacked layer of a plurality of layers, such as a silicon nitride layer, a silicon oxynitride layer, and a silicon nitride oxide layer be used as the insulating layer 220 over the separation layer. The use of the high-melting-point metal material for the separation layer can increase the formation temperature of a layer formed in a later step, which reduces impurity concentration and achieves a highly reliable display panel.

As the conductive layer 111a, an oxide or a nitride such as a metal oxide, a metal nitride, or an oxide such as an oxide semiconductor whose resistance is reduced is preferably used. In the case of using an oxide semiconductor, a material in which at least one of the concentrations of hydrogen, boron, phosphorus, nitrogen, and other impurities and the number of oxygen vacancies is made to be higher than those in a semiconductor layer of a transistor is used for the conductive layer 111a.

### [Components]

The above components will be described below.

### [Substrate]

A material having a flat surface can be used as the substrate included in the display panel. The substrate on the side from which light from the display element is extracted is formed using a material transmitting the light. For example, a material such as glass, quartz, ceramics, sapphire, or an organic resin can be used.

The weight and thickness of the display panel can be decreased by using a thin substrate. A flexible display panel can be obtained by using a substrate that is thin enough to have flexibility.

Since the substrate through which light emission is not extracted does not need to have a light-transmitting property, a metal substrate or the like can be used in addition to the above-mentioned substrates. A metal material, which has high thermal conductivity, is preferable because it can easily conduct heat to the whole substrate and accordingly can prevent a local temperature rise in the display panel. To obtain flexibility and bendability, the thickness of a metal substrate is preferably greater than or equal to 10 μm and less than or equal to 200 μm, further preferably greater than or equal to 20 μm and less than or equal to 50 μm.

Although there is no particular limitation on a material of a metal substrate, it is favorable to use, for example, a metal such as aluminum, copper, and nickel, an aluminum alloy, or an alloy such as stainless steel.

It is preferable to use a substrate subjected to insulation treatment, e.g., a metal substrate whose surface is oxidized or provided with an insulating film. An insulating film may be formed by, for example, a coating method such as a spin-coating method and a dipping method, an electrodeposition method, an evaporation method, or a sputtering method. An oxide film may be formed over the substrate surface by a known method such as an anodic oxidation method, exposing to or heating in an oxygen atmosphere, or the like.

Examples of the material that has flexibility and transmits visible light include glass that is thin enough to have flexibility, polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, a polyvinyl chloride resin, and a polytetrafluoroethylene (PTFE). It is particularly preferable to use a material with a low thermal expansion coefficient, for example, a material with a thermal expansion coefficient lower than or equal to 30×10⁻⁶/K, such as a polyamide imide resin, a polyimide resin, or PET. A substrate in which a glass fiber is impregnated with an organic resin or a substrate whose thermal expansion coefficient is reduced by mixing an inorganic filler with an organic resin can also be used. A substrate using such a material is lightweight, and thus a display panel using this substrate can also be lightweight.

In the case where a fibrous body is included in the above material, a high-strength fiber of an organic compound or an inorganic compound is used as the fibrous body. The high-strength fiber is specifically a fiber with a high tensile elastic modulus or a fiber with a high Young's modulus. Typical examples thereof include a polyvinyl alcohol based fiber, a polyester based fiber, a polyamide based fiber, a polyethylene based fiber, an aramid based fiber, a polyparaphenylene benzobisoxazole fiber, a glass fiber, and a carbon fiber. As the glass fiber, glass fiber using E glass, S glass, D glass, Q glass, or the like can be used. These fibers may be used in a state of a woven or nonwoven fabric, and a structure body in which this fibrous body is impregnated with a resin and the resin is cured may be used as the flexible substrate. The structure body including the fibrous body and the resin is preferably used as the flexible substrate, in which case the reliability against bending or breaking due to local pressure can be increased.

Alternatively, glass, metal, or the like that is thin enough to have flexibility can be used as the substrate. Alternatively, a composite material where glass and a resin material are attached to each other may be used.

A hard coat layer (e.g., a silicon nitride layer and an aluminum oxide layer) by which a surface of a display panel is protected from damage, a layer (e.g., an aramid resin layer) that can disperse pressure, or the like may be stacked over the flexible substrate. Furthermore, to suppress a decrease in the lifetime of the display element due to moisture and the like, an insulating film with low water permeability may be stacked over the flexible substrate. For example, an inorganic insulating material such as silicon nitride, silicon oxynitride, silicon nitride oxide, aluminum oxide, or aluminum nitride can be used.

The substrate may be formed by stacking a plurality of layers. When a glass layer is used, a barrier property against water and oxygen can be improved and thus a highly reliable display panel can be provided.

### [Transistor]

The transistor includes a conductive layer serving as the gate electrode, the semiconductor layer, a conductive layer serving as the source electrode, a conductive layer serving as the drain electrode, and an insulating layer serving as the gate insulating layer. In the above, a bottom-gate transistor is used.

Note that there is no particular limitation on the structure of the transistor included in the display device of one embodiment of the present invention. For example, a planar transistor, a staggered transistor, or an inverted staggered transistor may be used. A top-gate transistor or a bottom-gate transistor may be used. Gate electrodes may be provided above and below a channel.

There is no particular limitation on the crystallinity of a semiconductor material used for the transistors, and an amorphous semiconductor or a semiconductor having crystallinity (a microcrystalline semiconductor, a polycrystalline semiconductor, a single-crystal semiconductor, or a semiconductor partly including crystal regions) may be used. It is preferable that a semiconductor having crystallinity be used, in which case deterioration of the transistor characteristics can be suppressed.

As a semiconductor material used for the transistor, an element of Group 14 (e.g., silicon or germanium), a compound semiconductor, or an oxide semiconductor can be used, for example. Typically, a semiconductor containing silicon, a semiconductor containing gallium arsenide, an oxide semiconductor containing indium, or the like can be used.

In particular, an oxide semiconductor having a wider band gap than silicon is preferably used. A semiconductor material having a wider band gap and a lower carrier density than silicon is preferably used because the off-state leakage current of the transistor can be reduced.

For the semiconductor layer, it is particularly preferable to use an oxide semiconductor including a plurality of crystal parts whose c-axes are aligned substantially perpendicular to a surface on which the semiconductor layer is formed or the top surface of the semiconductor layer and in which a grain boundary is not observed between adjacent crystal parts.

There is no grain boundary in such an oxide semiconductor; therefore, generation of a crack in an oxide semiconductor film which is caused by stress when a display panel is bent is prevented. Therefore, such an oxide semiconductor can be preferably used for a flexible display panel which is used in a bent state, or the like.

Moreover, the use of such an oxide semiconductor with crystallinity for the semiconductor layer makes it possible to provide a highly reliable transistor with a small change in electrical characteristics.

A transistor with an oxide semiconductor whose band gap is larger than the band gap of silicon has a low off-state current and therefore can hold charges stored in a capacitor that is series-connected to the transistor for a long time. When such a transistor is used for a pixel, operation of a driver circuit can be stopped while a gray scale of each pixel is maintained. As a result, a display device with extremely low power consumption can be obtained.

The semiconductor layer preferably includes, for example, a film represented by an In-M-Zn-based oxide that contains at least indium, zinc, and M (a metal such as aluminum, titanium, gallium, germanium, yttrium, zirconium, lanthanum, cerium, tin, neodymium, or hafnium). In order to reduce variations in electrical characteristics of the transistor including the oxide semiconductor, the oxide semiconductor preferably contains a stabilizer in addition to indium, zinc, and M.

Examples of the stabilizer, including metals that can be used as M, are gallium, tin, hafnium, aluminum, and zirconium. As another stabilizer, lanthanoid such as lanthanum, cerium, praseodymium, neodymium, samarium, europium, gadolinium, terbium, dysprosium, holmium, erbium, thulium, ytterbium, or lutetium can be given.

As an oxide semiconductor included in the semiconductor layer, any of the following can be used, for example: an In—Ga—Zn-based oxide, an In—Al—Zn-based oxide, an In—Sn—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, and an In—Hf—Al—Zn-based oxide.

Note that here, an “In—Ga—Zn-based oxide” means an oxide containing In, Ga, and Zn as its main components, and there is no limitation on the ratio of In:Ga:Zn. The In—Ga—Zn-based oxide may contain another metal element in addition to In, Ga, and Zn.

The semiconductor layer and the conductive layer may include the same metal elements contained in the above oxides. The use of the same metal elements for the semiconductor layer and the conductive layer can reduce the manufacturing cost. For example, when metal oxide targets with the same metal composition are used, the manufacturing cost can be reduced, and the same etching gas or the same etchant can be used in processing the semiconductor layer and the conductive layer. Note that even when the semiconductor layer and the conductive layer include the same metal elements, they have different compositions in some cases. For example, a metal element in a film is released during the manufacturing process of the transistor and the capacitor, which might result in different metal compositions.

The energy gap of the oxide semiconductor contained in the semiconductor layer is preferably 2 eV or more, further preferably 2.5 eV or more, and still further preferably 3 eV or more. With the use of an oxide semiconductor having such a wide energy gap, the off-state current of the transistor can be reduced.

In the case where the oxide semiconductor contained in the semiconductor layer contains an In-M-Zn oxide, it is preferable that the atomic ratio of metal elements of a sputtering target used for forming a film of the In-M-Zn oxide satisfy In≧M and Zn≧M As the atomic ratio of metal elements of such a sputtering target, In:M:Zn=1:1:1, In:M:Zn=1:1:1.2, In:M:Zn=3:1:2, In:M:Zn=4:2:4.1 and the like are preferable. Note that the atomic ratio of metal elements in the formed semiconductor layer varies from the above atomic ratio of metal elements of the sputtering target within a range of ±40% as an error.

An oxide semiconductor film with low carrier density is used as the semiconductor layer. For example, the semiconductor layer is an oxide semiconductor film whose carrier density is lower than or equal to 1×10¹⁷/cm³, preferably lower than or equal to 1×10¹⁵/cm³, further preferably lower than or equal to 1×10¹³/cm³, still further preferably lower than or equal to 1×10¹¹/cm³, even further preferably lower than 1×10¹° /cm³, and higher than or equal to 1×10⁹/cm³. Such an oxide semiconductor is referred to as a highly purified intrinsic or substantially highly purified intrinsic oxide semiconductor. The oxide semiconductor has a low impurity concentration and a low density of defect states and can thus be referred to as an oxide semiconductor having stable characteristics.

Note that, without limitation to those described above, a material with an appropriate composition may be used depending on required semiconductor characteristics and electrical characteristics (e.g., field-effect mobility and threshold voltage) of a transistor. To obtain the required semiconductor characteristics of the transistor, it is preferable that the carrier density, the impurity concentration, the defect density, the atomic ratio between a metal element and oxygen, the interatomic distance, the density, and the like of the semiconductor layer be set to appropriate values.

When silicon or carbon that is one of elements belonging to Group 14 is contained in the oxide semiconductor contained in the semiconductor layer, oxygen vacancies are increased in the semiconductor layer, and the semiconductor layer becomes n-type. Thus, the concentration of silicon or carbon (measured by secondary ion mass spectrometry) in the semiconductor layer is lower than or equal to 2×10¹⁸ atoms/cm³, preferably lower than or equal to 2×10¹⁷ atoms/cm³.

Alkali metal and alkaline earth metal might generate carriers when bonded to an oxide semiconductor, in which case the off-state current of the transistor might be increased. Therefore, the concentration of alkali metal or alkaline earth metal of the semiconductor layer, which is measured by secondary ion mass spectrometry, is lower than or equal to 1×10¹⁸ atoms/cm³, preferably lower than or equal to 2×10¹⁶ atoms/cm³.

When nitrogen is contained in the oxide semiconductor contained in the semiconductor layer, electrons serving as carriers are generated and the carrier density increases, so that the semiconductor layer easily becomes n-type. Thus, a transistor including an oxide semiconductor which contains nitrogen is likely to be normally on. Hence, the concentration of nitrogen which is measured by secondary ion mass spectrometry is preferably set to lower than or equal to 5×10¹⁸ atoms/cm³.

The semiconductor layer may have a non-single-crystal structure, for example. The non-single-crystal structure includes CAAC-OS (c-axis aligned crystalline oxide semiconductor, or c-axis aligned a-b-plane-anchored crystalline oxide semiconductor), a polycrystalline structure, a microcrystalline structure, or an amorphous structure, for example. Among the non-single-crystal structures, an amorphous structure has the highest density of defect states, whereas CAAC-OS has the lowest density of defect states.

An oxide semiconductor film having an amorphous structure has disordered atomic arrangement and no crystalline component, for example. Alternatively, an oxide film having an amorphous structure has, for example, an absolutely amorphous structure and no crystal part.

Note that the semiconductor layer may be a mixed film including two or more of the following: a region having an amorphous structure, a region having a microcrystalline structure, a region having a polycrystalline structure, a region of CAAC-OS, and a region having a single-crystal structure. The mixed film has, for example, a single-layer structure or a stacked-layer structure including two or more of the above-described regions in some cases.

Alternatively, silicon is preferably used as a semiconductor in which a channel of a transistor is formed. Although amorphous silicon may be used as silicon, silicon having crystallinity is particularly preferable. For example, microcrystalline silicon, polycrystalline silicon, single-crystal silicon, or the like is preferably used. In particular, polycrystalline silicon can be formed at a lower temperature than single-crystal silicon and has higher field effect mobility and higher reliability than amorphous silicon. When such a polycrystalline semiconductor is used for a pixel, the aperture ratio of the pixel can be improved. Even in the case where the display portion with extremely high definition is provided, a gate driver circuit and a source driver circuit can be formed over a substrate over which the pixels are formed, and the number of components of an electronic device can be reduced.

The bottom-gate transistor described in this embodiment is preferable because the number of manufacturing steps can be reduced. When amorphous silicon, which can be formed at a lower temperature than polycrystalline silicon, is used for the semiconductor layer, materials with low heat resistance can be used for a wiring, an electrode, or a substrate below the semiconductor layer, resulting in wider choice of materials. For example, an extremely large glass substrate can be favorably used. Meanwhile, the top-gate transistor is preferable because an impurity region is easily formed in a self-aligned manner and variation in characteristics can be reduced. In that case, the use of polycrystalline silicon, single-crystal silicon, or the like is particularly preferable.

[Conductive layer]

As materials for a gate, a source, and a drain of a transistor, and a wiring or an electrode included in a display device, any of metals such as aluminum, titanium, chromium, nickel, copper, yttrium, zirconium, molybdenum, silver, tantalum, and tungsten, or an alloy containing any of these metals as its main component can be used. A single-layer structure or multi-layer structure including a film containing any of these materials can be used. For example, the following structures can be given: a single-layer structure of an aluminum film containing silicon, a two-layer structure in which an aluminum film is stacked over a titanium film, a two-layer structure in which an aluminum film is stacked over a tungsten film, a two-layer structure in which a copper film is stacked over a copper-magnesium-aluminum alloy film, a two-layer structure in which a copper film is stacked over a titanium film, a two-layer structure in which a copper film is stacked over a tungsten film, a three-layer structure in which a titanium film or a titanium nitride film, an aluminum film or a copper film, and a titanium film or a titanium nitride film are stacked in this order, and a three-layer structure in which a molybdenum film or a molybdenum nitride film, an aluminum film or a copper film, and a molybdenum film or a molybdenum nitride film are stacked in this order. Note that an oxide such as indium oxide, tin oxide, or zinc oxide may be used. Copper containing manganese is preferably used because controllability of a shape by etching is increased.

As a light-transmitting conductive material, a conductive oxide such as indium oxide, indium tin oxide, indium zinc oxide, zinc oxide, or zinc oxide to which gallium is added, or graphene can be used. Alternatively, a metal material such as gold, silver, platinum, magnesium, nickel, tungsten, chromium, molybdenum, iron, cobalt, copper, palladium, or titanium, or an alloy material containing any of these metal materials can be used. Alternatively, a nitride of the metal material (e.g., titanium nitride) or the like may be used. In the case of using the metal material or the alloy material (or the nitride thereof), the thickness is set small enough to be able to transmit light. Alternatively, a stack of any of the above materials can be used as the conductive layer. For example, a stacked film of indium tin oxide and an alloy of silver and magnesium is preferably used because the conductivity can be increased. They can also be used for conductive layers such as a variety of wirings and electrodes included in a display device, and a conductive layer (e.g., a conductive layer functioning as a pixel electrode or a common electrode) included in a display element.

### [Insulating Layer]

Examples of an insulating material that can be used for the insulating layers include a resin such as acrylic or epoxy resin, a resin having a siloxane bond, and an inorganic insulating material such as silicon oxide, silicon oxynitride, silicon nitride oxide, silicon nitride, or aluminum oxide.

The light-emitting element is preferably provided between a pair of insulating films with low water permeability, in which case impurities such as water can be prevented from entering the light-emitting element. Thus, a decrease in device reliability can be prevented.

As an insulating film with low water permeability, a film containing nitrogen and silicon (e.g., a silicon nitride film or a silicon nitride oxide film), a film containing nitrogen and aluminum (e.g., an aluminum nitride film), or the like can be used. Alternatively, a silicon oxide film, a silicon oxynitride film, an aluminum oxide film, or the like can be used.

For example, the water vapor transmittance of the insulating film with low water permeability is lower than or equal to 1×10⁻⁵ [g/m²·day], preferably lower than or equal to 1×10⁻⁶ [g/m²·day], further preferably lower than or equal to 1×10⁻⁷ [g/m²·day], and still further preferably lower than or equal to 1×10⁻⁸ [g/m²·day].

### [Liquid Crystal Element]

The liquid crystal element can employ, for example, a vertical alignment (VA) mode. Examples of the vertical alignment mode include a multi-domain vertical alignment (MVA) mode, a patterned vertical alignment (PVA) mode, and an advanced super view (ASV) mode.

The liquid crystal element can employ a variety of modes. For example, a liquid crystal element using, instead of a VA mode, a twisted nematic (TN) mode, an in-plane switching (IPS) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, or the like can be used.

The liquid crystal element controls transmission or non-transmission of light utilizing an optical modulation action of liquid crystal. Note that optical modulation action of liquid crystal is controlled by an electric field applied to the liquid crystal (including a horizontal electric field, a vertical electric field, or an oblique electric field). As the liquid crystal used for the liquid crystal element, thermotropic liquid crystal, low-molecular liquid crystal, high-molecular liquid crystal, polymer dispersed liquid crystal (PDLC), ferroelectric liquid crystal, anti-ferroelectric liquid crystal, or the like can be used. These liquid crystal materials exhibit a cholesteric phase, a smectic phase, a cubic phase, a chiral nematic phase, an isotropic phase, or the like depending on conditions.

As the liquid crystal material, either of a positive liquid crystal and a negative liquid crystal may be used, and an appropriate liquid crystal material can be used depending on the mode or design to be used.

In addition, to control the alignment of the liquid crystal, an alignment film can be provided. Alternatively, when a horizontal electric field mode is employed, a liquid crystal exhibiting a blue phase for which an alignment film is unnecessary may be used. A blue phase is one of liquid crystal phases, which is generated just before a cholesteric phase changes into an isotropic phase while the temperature of cholesteric liquid crystal is increased. Since the blue phase appears only in a narrow temperature range, a liquid crystal composition in which several weight percent or more of a chiral material is mixed is used for the liquid crystal layer in order to improve the temperature range. The liquid crystal composition which includes liquid crystal exhibiting a blue phase and a chiral material has a short response time and optical isotropy. In addition, the liquid crystal composition which includes liquid crystal exhibiting a blue phase and a chiral material does not need alignment treatment and has a small viewing angle dependence. An alignment film does not need to be provided and rubbing treatment is thus not necessary; accordingly, electrostatic discharge damage caused by the rubbing treatment can be prevented and defects and damage of the liquid crystal display device in the manufacturing process can be reduced.

As the liquid crystal element, a transmissive liquid crystal element, a reflective liquid crystal element, a semi-transmissive liquid crystal element, or the like can be used.

In one embodiment of the present invention, in particular, the reflective liquid crystal element can be used.

In the case where the transmissive or semi-transmissive liquid crystal element is used, two polarizing plates are provided so that a pair of substrates is sandwiched therebetween. A backlight is provided outside one of the polarizing plates. As the backlight, a direct-below backlight or an edge-light backlight may be used. The direct-below backlight including a light-emittng diode (LED) is preferably used because local dimming is easily performed to improve contrast. The edge-light type backlight is preferably used because the thickness of a module including the backlight can be reduced.

In the case where the reflective liquid crystal element is used, the polarizing plate is provided on the display surface side. Separately, a light diffusion plate is preferably provided on the display surface to improve visibility.

In the case where the reflective or the semi-transmissive liquid crystal element is used, a front light may be provided outside the polarizing plate. As the front light, an edge-light front light is preferably used. A front light including an LED is preferably used because power consumption can be reduced.

### [Light-Emitting Element]

As the light-emitting element, a self-luminous element can be used, and an element whose luminance is controlled by current or voltage is included in the category of the light-emitting element. For example, an LED, an organic EL element, an inorganic EL element, or the like can be used.

The light-emitting element has a top emission structure, a bottom emission structure, a dual emission structure, or the like. A conductive film that transmits visible light is used as the electrode through which light is extracted. A conductive film that reflects visible light is preferably used as the electrode through which light is not extracted.

In one embodiment of the present invention, in particular, a bottom-emission light-emitting element can be used.

The EL layer includes at least a light-emitting layer. In addition to the light-emitting layer, the EL layer may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

Either a low molecular compound or a high molecular compound can be used for the EL layer, and an inorganic compound may also be used. The layers included in the EL layer can be formed by any of the following methods: an evaporation method (including a vacuum evaporation method), a transfer method, a printing method, an inkjet method, a coating method, and the like.

When a voltage higher than the threshold voltage of the light-emitting element is applied between the anode and the cathode, holes are injected to the EL layer from the anode side and electrons are injected to the EL layer from the cathode side. The injected electrons and holes are recombined in the EL layer, so that a light-emitting substance contained in the EL layer emits light.

In the case where a light-emitting element emitting white light is used as the light-emitting element, the EL layer preferably contains two or more kinds of light-emitting substances. For example, light-emitting substances are selected so that two or more light-emitting substances emit complementary colors to obtain white light emission. Specifically, it is preferable to contain two or more light-emitting substances selected from light-emitting substances emitting light of red (R), green (G), blue (B), yellow (Y), orange (O), and the like and light-emitting substances emitting light containing two or more of spectral components of R, G, and B. The light-emitting element preferably emits light with a spectrum having two or more peaks in the wavelength range of a visible light region (e.g., 350 nm to 750 nm). An emission spectrum of a material emitting light having a peak in the wavelength range of a yellow light preferably includes spectral components also in the wavelength range of a green light and a red light.

A light-emitting layer containing a light-emitting material emitting light of one color and a light-emitting layer containing a light-emitting material emitting light of another color are preferably stacked in the EL layer. For example, the plurality of light-emitting layers in the EL layer may be stacked in contact with each other or may be stacked with a region not including any light-emitting material therebetween. For example, between a fluorescent layer and a phosphorescent layer, a region containing the same material as one in the fluorescent layer or phosphorescent layer (for example, a host material or an assist material) and no light-emitting material may be provided. This facilitates the manufacture of the light-emitting element and reduces the drive voltage.

The light-emitting element may be a single element including one EL layer or a tandem element in which a plurality of EL layers are stacked with a charge generation layer therebetween.

The conductive film that transmits visible light can be formed using, for example, indium oxide, indium tin oxide, indium zinc oxide, zinc oxide, or zinc oxide to which gallium is added. Alternatively, a film of a metal material such as gold, silver, platinum, magnesium, nickel, tungsten, chromium, molybdenum, iron, cobalt, copper, palladium, or titanium; an alloy containing any of these metal materials; or a nitride of any of these metal materials (e.g., titanium nitride) can be used when formed thin so as to have a light-transmitting property. Alternatively, a stack of any of the above materials can be used as the conductive layer. For example, a stacked film of indium tin oxide and an alloy of silver and magnesium is preferably used, in which case conductivity can be increased. Further alternatively, graphene or the like may be used.

For the conductive film that reflects visible light, for example, a metal material, such as aluminum, gold, platinum, silver, nickel, tungsten, chromium, molybdenum, iron, cobalt, copper, or palladium or an alloy including any of these metal materials can be used. Lanthanum, neodymium, germanium, or the like may be added to the metal material or the alloy. Alternatively, an alloy containing aluminum (an aluminum alloy) such as an alloy of aluminum and titanium, an alloy of aluminum and nickel, or an alloy of aluminum and neodymium may be used. Alternatively, an alloy containing silver such as an alloy of silver and copper, an alloy of silver and palladium, or an alloy of silver and magnesium may be used. An alloy of silver and copper is preferable because of its high heat resistance. Furthermore, when a metal film or a metal oxide film is stacked in contact with an aluminum film or an aluminum alloy film, oxidation can be suppressed. Examples of a material for the metal film or the metal oxide film include titanium and titanium oxide. Alternatively, the conductive film having a property of transmitting visible light and a film containing any of the above metal materials may be stacked. For example, a stack of silver and indium tin oxide, a stack of an alloy of silver and magnesium and indium tin oxide, or the like can be used.

The electrodes may be formed separately by an evaporation method or a sputtering method. Alternatively, a discharging method such as an inkjet method, a printing method such as a screen printing method, or a plating method may be used.

Note that the aforementioned light-emitting layer and layers containing a substance with a high hole-injection property, a substance with a high hole-transport property, a substance with a high electron-transport property, a substance with a high electron-injection property, and a substance with a bipolar property may include an inorganic compound such as a quantum dot or a high molecular compound (e.g., an oligomer, a dendrimer, and a polymer). For example, used for the light-emitting layer, the quantum dot can serve as a light-emitting material.

The quantum dot may be a colloidal quantum dot, an alloyed quantum dot, a core-shell quantum dot, a core quantum dot, or the like. The quantum dot containing elements belonging to Groups 12 and 16, elements belonging to Groups 13 and 15, or elements belonging to Groups 14 and 16, may be used. Alternatively, the quantum dot containing an element such as cadmium, selenium, zinc, sulfur, phosphorus, indium, tellurium, lead, gallium, arsenic, or aluminum may be used.

### [Adhesive Layer]

As the adhesive layer, a variety of curable adhesives such as a reactive curable adhesive, a thermosetting adhesive, an anaerobic adhesive, and a photocurable adhesive such as an ultraviolet curable adhesive can be used. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin. In particular, a material with low moisture permeability, such as an epoxy resin, is preferred. Alternatively, a two-component-mixture-type resin may be used. Further alternatively, an adhesive sheet or the like may be used.

Furthermore, the resin may include a drying agent. For example, a substance that adsorbs water by chemical adsorption, such as oxide of an alkaline earth metal (e.g., calcium oxide or barium oxide), can be used. Alternatively, a substance that adsorbs water by physical adsorption, such as zeolite or silica gel, may be used. The drying agent is preferably included because it can prevent impurities such as water from entering the element, thereby improving the reliability of the display panel.

In addition, it is preferable to mix a filler with a high refractive index or light-scattering member into the resin, in which case light extraction efficiency can be enhanced. For example, titanium oxide, barium oxide, zeolite, zirconium, or the like can be used.

### [Connection Layer]

As the connection layers, an anisotropic conductive film (ACF), an anisotropic conductive paste (ACP), or the like can be used.

### [Coloring Layer]

Examples of a material that can be used for the coloring layers include a metal material, a resin material, and a resin material containing a pigment or dye.

### [Light-Blocking Layer]

Examples of a material that can be used for the light-blocking layer include carbon black, titanium black, a metal, a metal oxide, and a composite oxide containing a solid solution of a plurality of metal oxides. The light-blocking layer may be a film containing a resin material or a thin film of an inorganic material such as a metal. Stacked films containing the material of the coloring layer can also be used for the light-blocking layer. For example, a stacked-layer structure of a film containing a material of a coloring layer which transmits light of a certain color and a film containing a material of a coloring layer which transmits light of another color can be employed. It is preferable that the coloring layer and the light-blocking layer be formed using the same material because the same manufacturing apparatus can be used and the process can be simplified.

The above is the description of the components.

### [Manufacturing Method Example]

A manufacturing method example of a display panel using a flexible substrate is described.

Here, layers each including a display element, a circuit, a wiring, an electrode, optical members such as a coloring layer and a light-blocking layer, an insulating layer, and the like, are collectively referred to as an element layer. The element layer includes, for example, a display element, and may additionally include a wiring electrically connected to the display element or an element such as a transistor used in a pixel or a circuit.

In addition, here, a flexible member which supports the element layer at a stage at which the display element is completed (the manufacturing process is finished) is referred to as a substrate. For example, a substrate includes an extremely thin film with a thickness greater than or equal to 10 nm and less than or equal to 300 μm and the like.

As a method for forming an element layer over a flexible substrate provided with an insulating surface, typically, there are two methods shown below. One of them is to directly form an element layer over the substrate. The other method is to form an element layer over a support substrate that is different from the substrate and then to separate the element layer from the support substrate to be transferred to the substrate. Although not described in detail here, in addition to the above two methods, there is a method in which the element layer is formed over a substrate which does not have flexibility and the substrate is thinned by polishing or the like to have flexibility.

In the case where a material of the substrate can withstand heating temperature in a process for forming the element layer, it is preferable that the element layer be formed directly over the substrate, in which case a manufacturing process can be simplified. At this time, the element layer is preferably formed in a state where the substrate is fixed to a support substrate, in which case transfer thereof in an apparatus and between apparatuses can be easy.

In the case of employing the method in which the element layer is formed over the support substrate and then transferred to the substrate, first, a separation layer and an insulating layer are stacked over the support substrate, and then the element layer is formed over the insulating layer. Next, the element layer is separated from the support substrate and then transferred to the substrate. At this time, selected is a material with which separation at an interface between the support substrate and the separation layer, at an interface between the separation layer and the insulating layer, or in the separation layer occurs. With the method, it is preferable that a material having high heat resistance be used for the support substrate or the separation layer, in which case the upper limit of the temperature applied when the element layer is formed can be increased, and an element layer including a higher reliable element can be formed.

For example, it is preferable that a stack of a layer containing a high-melting-point metal material, such as tungsten, and a layer containing an oxide of the metal material be used as the separation layer, and a stack of a plurality of layers, such as a silicon oxide layer, a silicon nitride layer, a silicon oxynitride layer, and a silicon nitride oxide layer be used as the insulating layer over the separation layer. Note that in this specification, oxynitride contains more oxygen than nitrogen, and nitride oxide contains more nitrogen than oxygen.

As the method for separating the support substrate from the element layer, applying mechanical force, etching the separation layer, and making a liquid permeate the separation interface are given as examples. Alternatively, separation may be performed by heating or cooling the support substrate by utilizing a difference in thermal expansion coefficient of two layers which form the separation interface.

The separation layer is not necessarily provided in the case where the separation can be performed at an interface between the support substrate and the insulating layer.

For example, glass and an organic resin such as polyimide can be used as the support substrate and the insulating layer, respectively. In that case, a separation trigger may be formed by, for example, locally heating part of the organic resin with laser light or the like, or by physically cutting part of or making a hole through the organic resin with a sharp tool, so that separation may be performed at an interface between the glass and the organic resin.

Alternatively, a heat generation layer may be provided between the support substrate and the insulating layer formed of an organic resin, and separation may be performed at an interface between the heat generation layer and the insulating layer by heating the heat generation layer. As the heat generation layer, any of a variety of materials such as a material which generates heat by feeding current, a material which generates heat by absorbing light, and a material which generates heat by applying a magnetic field can be used. For example, for the heat generation layer, a material selected from a semiconductor, a metal, and an insulator can be used.

In the above-described methods, the insulating layer formed of an organic resin can be used as a substrate after the separation.

The above is the description of a manufacturing method of a flexible display panel.

At least part of this embodiment can be implemented in combination with any of the other embodiments and the other examples described in this specification as appropriate.

### Embodiment 3

In this embodiment, an example of a transistor that can be used as the transistors described in the above embodiments will be described with reference to drawings.

The display device of one embodiment of the present invention can be fabricated by using a transistor with any of various modes, such as a bottom-gate transistor or a top-gate transistor. Therefore, a material for a semiconductor layer or the structure of a transistor can be easily changed in accordance with the existing production line.

### [Bottom-Gate Transistor]

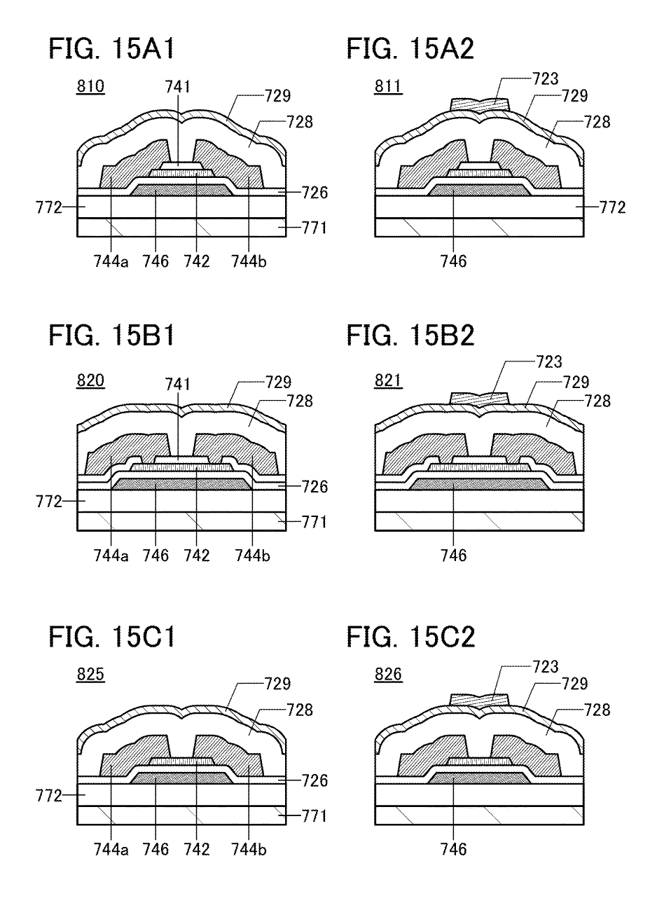

FIG. 15A1 is a cross-sectional view of a transistor 810 that is a channel-protective transistor, which is a type of bottom-gate transistor. In FIG. 15A1, the transistor 810 is formed over a substrate 771. The transistor 810 includes an electrode 746 over the substrate 771 with an insulating layer 772 provided therebetween. The transistor 810 includes a semiconductor layer 742 over the electrode 746 with an insulating layer 726 provided therebetween. The electrode 746 can serve as a gate electrode. The insulating layer 726 can serve as a gate insulating layer.

The transistor 810 includes an insulating layer 741 over a channel formation region in the semiconductor layer 742. The transistor 810 includes an electrode 744a and an electrode 744b which are partly in contact with the semiconductor layer 742 and over the insulating layer 726. The electrode 744a can serve as one of a source electrode and a drain electrode. The electrode 744b can serve as the other of the source electrode and the drain electrode. Part of the electrode 744a and part of the electrode 744b are formed over the insulating layer 741.

The insulating layer 741 can serve as a channel protective layer. With the insulating layer 741 provided over the channel formation region, the semiconductor layer 742 can be prevented from being exposed at the time of forming the electrodes 744a and 744b. Thus, the channel formation region in the semiconductor layer 742 can be prevented from being etched at the time of forming the electrodes 744a and 744b. According to one embodiment of the present invention, a transistor with favorable electrical characteristics can be provided.

The transistor 810 includes an insulating layer 728 over the electrode 744a, the electrode 744b, and the insulating layer 741 and further includes an insulating layer 729 over the insulating layer 728.

For example, the insulating layer 772 can be formed using a material and a method similar to those of insulating layers 722 and 705. Note that the insulating layer 772 may be formed of a stack of insulating layers. For example, the semiconductor layer 742 can be formed using a material and a method similar to those of the semiconductor layer 708. Note that the semiconductor layer 742 may be formed of a stack of semiconductor layers. For example, the electrode 746 can be formed using a material and a method similar to those of the electrode 706. Note that the electrode 746 may be formed of a stack of conductive layers. The insulating layer 726 can be formed using a material and a method similar to those of the insulating layer 707. Note that the insulating layer 726 may be formed of a stack of insulating layers. For example, the electrodes 744a and 744b can be formed using a material and a method similar to those of the electrode 714 or 715. Note that the electrodes 744a and 744b may be formed of a stack of conductive layers. For example, the insulating layer 741 can be formed using a material and a method similar to those of the insulating layer 726. Note that the insulating layer 741 may be formed of a stack of insulating layers. For example, the insulating layer 728 can be formed using a material and a method similar to those of the insulating layer 710. Note that the insulating layer 728 may be formed of a stack of insulating layers. For example, the insulating layer 729 can be formed using a material and a method similar to those of the insulating layer 711. Note that the insulating layer 729 may be formed of a stack of insulating layers.

The electrode, the semiconductor layer, the insulating layer, and the like used in the transistor disclosed in this embodiment can be formed using a material and a method disclosed in any of the other embodiments.

In the case where an oxide semiconductor is used for the semiconductor layer 742, a material capable of removing oxygen from part of the semiconductor layer 742 to generate oxygen vacancies is preferably used for regions of the electrodes 744a and 744b that are in contact with at least the semiconductor layer 742. The carrier concentration in the regions of the semiconductor layer 742 where oxygen vacancies are generated is increased, so that the regions become n-type regions (n⁺ layers). Accordingly, the regions can serve as a source region and a drain region. When an oxide semiconductor is used for the semiconductor layer 742, examples of the material capable of removing oxygen from the semiconductor layer 742 to generate oxygen vacancies include tungsten and titanium.

Formation of the source region and the drain region in the semiconductor layer 742 makes it possible to reduce the contact resistance between the semiconductor layer 742 and each of the electrodes 744a and 744b. Accordingly, the electric characteristics of the transistor, such as the field-effect mobility and the threshold voltage, can be favorable.

In the case where a semiconductor such as silicon is used for the semiconductor layer 742, a layer that serves as an n-type semiconductor or a p-type semiconductor is preferably provided between the semiconductor layer 742 and the electrode 744a and between the semiconductor layer 742 and the electrode 744b. The layer that serves as an n-type semiconductor or a p-type semiconductor can serve as the source region or the drain region in the transistor.

The insulating layer 729 is preferably formed using a material that can prevent or reduce diffusion of impurities into the transistor from the outside. The insulating layer 729 is not necessarily formed.

When an oxide semiconductor is used for the semiconductor layer 742, heat treatment may be performed before and/or after the insulating layer 729 is formed. The heat treatment can fill oxygen vacancies in the semiconductor layer 742 by diffusing oxygen contained in the insulating layer 729 or other insulating layers into the semiconductor layer 742. Alternatively, the insulating layer 729 may be formed while the heat treatment is performed, so that oxygen vacancies in the semiconductor layer 742 can be filled.

Note that a CVD method can be generally classified into a plasma enhanced CVD (PECVD) method using plasma, a thermal CVD (TCVD) method using heat, and the like. A CVD method can be further classified into a metal CVD (MCVD) method, a metal organic CVD (MOCVD) method, and the like according to a source gas to be used.

Furthermore, an evaporation method can be generally classified into a resistance heating evaporation method, an electron beam evaporation method, a molecular beam epitaxy (MBE) method, a pulsed laser deposition (PLD) method, an ion beam assisted deposition (IBAD) method, an atomic layer deposition (ALD) method, and the like.

By using a PECVD method, a high-quality film can be formed at a relatively low temperature. By using a deposition method that does not use plasma for deposition, such as an MOCVD method or an evaporation method, a film with few defects can be formed because damage is not easily caused on a surface on which the film is deposited.

A sputtering method is generally classified into a DC sputtering method, a magnetron sputtering method, an RF sputtering method, an ion beam sputtering method, an electron cyclotron resonance (ECR) sputtering method, a facing-target sputtering method, and the like.

In the facing-target sputtering method, plasma is confined between targets; thus, plasma damage to a substrate can be reduced. Furthermore, step coverage can be improved because the incident angle of a sputtered particle to a substrate can be made smaller depending on the inclination of a target.

A transistor 811 illustrated in FIG. 15A2 is different from the transistor 810 in that an electrode 723 that can serve as a back gate electrode is provided over the insulating layer 729. The electrode 723 can be formed using a material and a method similar to those of the electrode 746.

In general, the back gate electrode is formed using a conductive layer and positioned so that a channel formation region of a semiconductor layer is positioned between the gate electrode and the back gate electrode. Thus, the back gate electrode can function in a manner similar to that of the gate electrode. The potential of the back gate electrode may be the same as that of the gate electrode or may be a ground (GND) potential or a predetermined potential. By changing the potential of the back gate electrode independently of the potential of the gate electrode, the threshold voltage of the transistor can be changed.

The electrode 746 and the electrode 723 can each serve as a gate electrode. Thus, the insulating layers 726, 728, and 729 can each serve as a gate insulating layer. The electrode 723 may also be provided between the insulating layers 728 and 729.

In the case where one of the electrodes 746 and 723 is referred to as a “gate electrode”, the other is referred to as a “back gate electrode”. For example, in the transistor 811, in the case where the electrode 723 is referred to as a “gate electrode”, the electrode 746 is referred to as a “back gate electrode”. In the case where the electrode 723 is used as a “gate electrode”, the transistor 811 can be regarded as a kind of top-gate transistor. Alternatively, one of the electrodes 746 and 723 may be referred to as a “first gate electrode”, and the other may be referred to as a “second gate electrode”.

By providing the electrodes 746 and 723 with the semiconductor layer 742 provided therebetween and setting the potentials of the electrodes 746 and 723 to be the same, a region of the semiconductor layer 742 through which carriers flow is enlarged in the film thickness direction; thus, the number of transferred carriers is increased. As a result, the on-state current and field-effect mobility of the transistor 811 are increased.

Therefore, the transistor 811 has a high on-state current for its area. That is, the area of the transistor 811 can be small for a required on-state current. According to one embodiment of the present invention, the area occupied by a transistor can be reduced. Therefore, according to one embodiment of the present invention, a semiconductor device having a high degree of integration can be provided.

The gate electrode and the back gate electrode are formed using conductive layers and thus each have a function of preventing an electric field generated outside the transistor from influencing the semiconductor layer in which the channel is formed (in particular, an electric field blocking function against static electricity and the like). When the back gate electrode is formed larger than the semiconductor layer such that the semiconductor layer is covered with the back gate electrode, the electric field blocking function can be enhanced.

Since the electrodes 746 and 723 each have a function of blocking an electric field generated outside, electric charge of charged particles and the like generated on the insulating layer 772 side or above the electrode 723 do not influence the channel formation region in the semiconductor layer 742. Thus, degradation by a stress test (e.g., a negative gate bias temperature (−GBT) stress test in which negative electric charge is applied to a gate) can be reduced. Furthermore, a change in gate voltage (rising voltage) at which on-state current starts flowing depending on drain voltage can be reduced. Note that this effect is obtained when the electrodes 746 and 723 have the same potential or different potentials.

The BT stress test is one kind of acceleration test and can evaluate, in a short time, a change by long-term use (i.e., a change over time) in characteristics of a transistor. In particular, the amount of change in the threshold voltage of a transistor before and after the BT stress test is an important indicator when examining the reliability of the transistor. As the change in threshold voltage is smaller, the transistor has higher reliability.

By providing the electrodes 746 and 723 and setting the potentials of the electrodes 746 and 723 to be the same, the amount of change in threshold voltage is reduced. Accordingly, variations in electrical characteristics among a plurality of transistors are also reduced.

A transistor including a back gate electrode has a smaller change in threshold voltage before and after a positive GBT stress test, in which positive electric charge is applied to a gate, than a transistor including no back gate electrode.

When the back gate electrode is formed using a light-blocking conductive film, light can be prevented from entering the semiconductor layer from the back gate electrode side. Therefore, photodegradation of the semiconductor layer can be prevented, and deterioration in electrical characteristics of the transistor, such as a shift of the threshold voltage, can be prevented.

According to one embodiment of the present invention, a transistor with high reliability can be provided. Moreover, a semiconductor device with high reliability can be provided.

FIG. 15B1 is a cross-sectional view of a channel-protective transistor 820 that is a type of bottom-gate transistor. The transistor 820 has substantially the same structure as the transistor 810 but is different from the transistor 810 in that the insulating layer 741 covers an end portion of the semiconductor layer 742. The semiconductor layer 742 is electrically connected to the electrode 744a through an opening formed by selectively removing part of the insulating layer 741 which overlaps with the semiconductor layer 742. The semiconductor layer 742 is electrically connected to the electrode 744b through another opening formed by selectively removing part of the insulating layer 741 which overlaps with the semiconductor layer 742. A region of the insulating layer 741 which overlaps with the channel formation region can serve as a channel protective layer.

A transistor 821 illustrated in FIG. 15B2 is different from the transistor 820 in that the electrode 723 that can serve as a back gate electrode is provided over the insulating layer 729.

With the insulating layer 741, the semiconductor layer 742 can be prevented from being exposed at the time of forming the electrodes 744a and 744b. Thus, the semiconductor layer 742 can be prevented from being reduced in thickness at the time of forming the electrodes 744a and 744b.

The length between the electrode 744a and the electrode 746 and the length between the electrode 744b and the electrode 746 in the transistors 820 and 821 are larger than those in the transistors 810 and 811. Thus, the parasitic capacitance generated between the electrode 744a and the electrode 746 can be reduced. Moreover, the parasitic capacitance generated between the electrode 744b and the electrode 746 can be reduced. According to one embodiment of the present invention, a transistor with favorable electrical characteristics can be provided.

A transistor 825 illustrated in FIG. 15C1 is a channel-etched transistor that is a type of bottom-gate transistor. In the transistor 825, the electrodes 744aand 744b are formed without providing the insulating layer 741. Thus, part of the semiconductor layer 742 that is exposed at the time of forming the electrodes 744a and 744b is etched in some cases. However, since the insulating layer 741 is not provided, the productivity of the transistor can be increased.

A transistor 826 illustrated in FIG. 15C2 is different from the transistor 825 in that the electrode 723 which can serve as a back gate electrode is provided over the insulating layer 729. [Top-Gate Transistor]

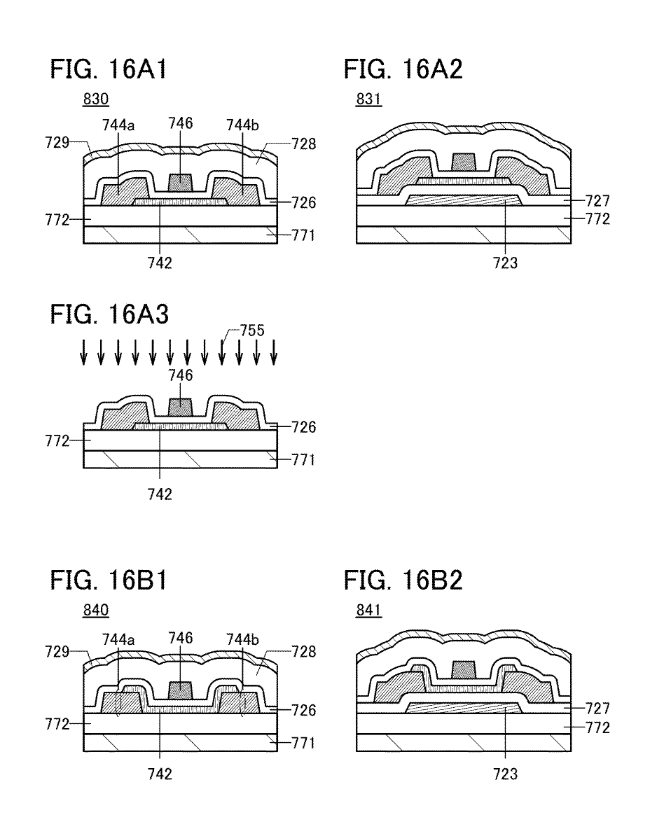

FIG. 16A1 is a cross-sectional view of a transistor 830 that is a type of top-gate transistor. The transistor 830 includes the semiconductor layer 742 over the insulating layer 772, the electrodes 744a and 744b that are over the semiconductor layer 742 and the insulating layer 772 and in contact with part of the semiconductor layer 742, the insulating layer 726 over the semiconductor layer 742 and the electrodes 744a and 744b, and the electrode 746 over the insulating layer 726.

Since the electrode 746 overlaps with neither the electrode 744a nor the electrode 744b in the transistor 830, the parasitic capacitance generated between the electrodes 746 and 744a and the parasitic capacitance generated between the electrodes 746 and 744b can be reduced. After the formation of the electrode 746, an impurity 755 is introduced into the semiconductor layer 742 using the electrode 746 as a mask, so that an impurity region can be formed in the semiconductor layer 742 in a self-aligned manner (see FIG. 16A3). According to one embodiment of the present invention, a transistor with favorable electrical characteristics can be provided.

The introduction of the impurity 755 can be performed with an ion implantation apparatus, an ion doping apparatus, or a plasma treatment apparatus.

As the impurity 755, for example, at least one kind of element of Group 13 elements and Group 15 elements can be used. In the case where an oxide semiconductor is used for the semiconductor layer 742, it is possible to use at least one kind of element of a rare gas, hydrogen, and nitrogen as the impurity 755.

A transistor 831 illustrated in FIG. 16A2 is different from the transistor 830 in that the electrode 723 and the insulating layer 727 are included. The transistor 831 includes the electrode 723 formed over the insulating layer 772 and the insulating layer 727 formed over the electrode 723. The electrode 723 can serve as a back gate electrode. Thus, the insulating layer 727 can serve as a gate insulating layer. The insulating layer 727 can be formed using a material and a method similar to those of the insulating layer 726.

Like the transistor 811, the transistor 831 has a high on-state current for its area. That is, the area of the transistor 831 can be small for a required on-state current. According to one embodiment of the present invention, the area occupied by a transistor can be reduced. Therefore, according to one embodiment of the present invention, a semiconductor device having a high degree of integration can be provided.

A transistor 840 illustrated in FIG. 16B1 is a type of top-gate transistor. The transistor 840 is different from the transistor 830 in that the semiconductor layer 742 is formed after the formation of the electrodes 744a and 744b. A transistor 841 illustrated in FIG. 16B2 is different from the transistor 840 in that the electrode 723 and the insulating layer 727 are included. In the transistors 840 and 841, part of the semiconductor layer 742 is formed over the electrode 744a and another part of the semiconductor layer 742 is formed over the electrode 744b.

Like the transistor 811, the transistor 841 has a high on-state current for its area. That is, the area of the transistor 841 can be small for a required on-state current. According to one embodiment of the present invention, the area occupied by a transistor can be reduced. Therefore, according to one embodiment of the present invention, a semiconductor device having a high degree of integration can be provided.

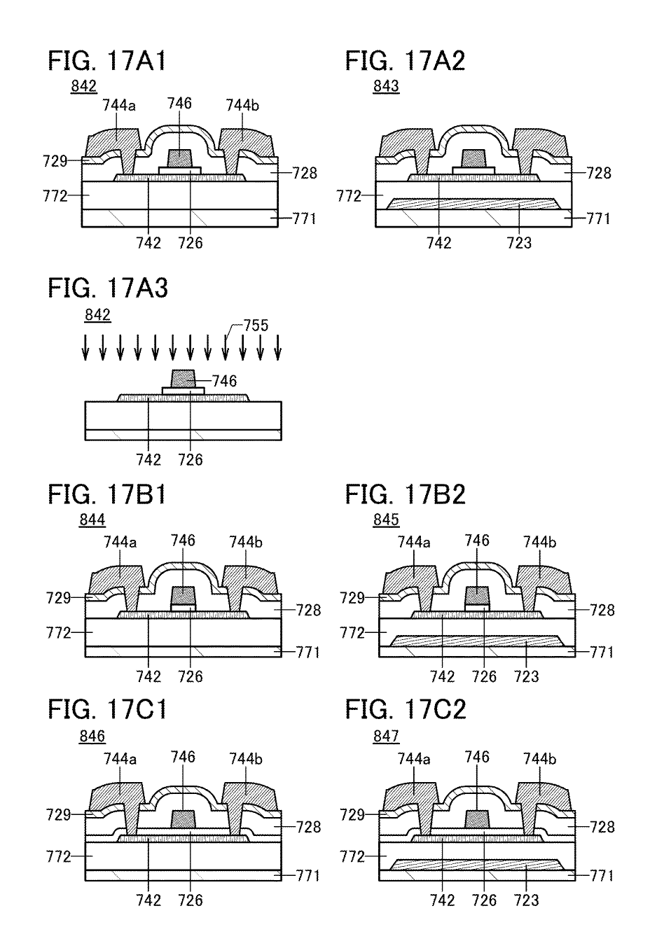

A transistor 842 illustrated in FIG. 17A1 is a type of top-gate transistor. The transistor 842 is different from the transistor 830 or 840 in that the electrodes 744a and 744b are formed after the formation of the insulating layer 729. The electrodes 744a and 744b are electrically connected to the semiconductor layer 742 through openings formed in the insulating layers 728 and 729.

Part of the insulating layer 726 that does not overlap with the electrode 746 is removed, and the impurity 755 is introduced into the semiconductor layer 742 using the electrode 746 and the insulating layer 726 that is left as a mask, so that an impurity region can be formed in the semiconductor layer 742 in a self-aligned manner (see FIG. 17A3). The transistor 842 includes a region where the insulating layer 726 extends beyond an end portion of the electrode 746. The semiconductor layer 742 in a region into which the impurity 755 is introduced through the insulating layer 726 has a lower impurity concentration than the semiconductor layer 742 in a region into which the impurity 755 is introduced without through the insulating layer 726. Thus, a lightly doped drain (LDD) region is formed in a region adjacent to a portion of the semiconductor layer 742 which overlaps with the electrode 746.

A transistor 843 illustrated in FIG. 17A2 is different from the transistor 842 in that the electrode 723 is included. The transistor 843 includes the electrode 723 that is formed over the substrate 771 and overlaps with the semiconductor layer 742 with the insulating layer 772 provided therebetween. The electrode 723 can serve as a back gate electrode.

As in a transistor 844 illustrated in FIG. 17B1 and a transistor 845 illustrated in FIG. 17B2, the insulating layer 726 in a region that does not overlap with the electrode 746 may be completely removed. Alternatively, as in a transistor 846 illustrated in FIG. 17C1 and a transistor 847 illustrated in FIG. 17C2, the insulating layer 726 may be left.

In the transistors 842 to 847, after the formation of the electrode 746, the impurity 755 is introduced into the semiconductor layer 742 using the electrode 746 as a mask, so that an impurity region can be formed in the semiconductor layer 742 in a self-aligned manner. According to one embodiment of the present invention, a transistor with favorable electrical characteristics can be provided. Furthermore, according to one embodiment of the present invention, a semiconductor device having a high degree of integration can be provided.

At least part of this embodiment can be implemented in combination with any of the other embodiments described in this specification as appropriate.

### Embodiment 4

In this embodiment, electronic devices and lighting devices of embodiments of the present invention are described with reference to drawings.

Electronic devices and lighting devices can be manufactured by using the display device of one embodiment of the present invention. Electronic devices and lighting devices with low power consumption can be manufactured by using the display device of one embodiment of the present invention. In addition, highly reliable electronic devices and highly reliable lighting devices can be manufactured using the display device of one embodiment of the present invention.

Examples of electronic devices include a television set, a desktop or laptop personal computer, a monitor of a computer or the like, a digital camera, a digital video camera, a digital photo frame, a mobile phone, a portable game machine, a portable information terminal, an audio reproducing device, and a large game machine such as a pachinko machine.

The electronic device or the lighting device of one embodiment of the present invention can be incorporated along a curved inside/outside wall surface of a house or a building or a curved interior/exterior surface of a car.

The electronic device of one embodiment of the present invention may include a secondary battery. Preferably, the secondary battery is capable of being charged by contactless power transmission.

Examples of the secondary battery include a lithium ion secondary battery such as a lithium polymer battery (lithium ion polymer battery) using a gel electrolyte, a nickel-hydride battery, a nickel-cadmium battery, an organic radical battery, a lead-acid battery, an air secondary battery, a nickel-zinc battery, and a silver-zinc battery.

The electronic device of one embodiment of the present invention may include an antenna. When a signal is received by the antenna, a video, information, or the like can be displayed on a display portion. When the electronic device includes an antenna and a secondary battery, the antenna may be used for contactless power transmission.

The electronic device of one embodiment of the present invention may include a sensor (a sensor having a function of measuring force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays).

The electronic device of one embodiment of the present invention can have a variety of functions such as a function of displaying a variety of information (e.g., a still image, a moving image, and a text image) on the display portion, a touch panel function, a function of displaying a calendar, date, time, and the like, a function of executing a variety of software (programs), a wireless communication function, and a function of reading out a program or data stored in a recording medium.

Furthermore, the electronic device including a plurality of display portions can have a function of displaying image information mainly on one display portion while displaying text information mainly on another display portion, a function of displaying a three-dimensional image by displaying images where parallax is considered on a plurality of display portions, or the like. Furthermore, the electronic device including an image receiving portion can have a function of photographing a still image or a moving image, a function of automatically or manually correcting a photographed image, a function of storing a photographed image in a recording medium (an external recording medium or a recording medium incorporated in the electronic device), a function of displaying a photographed image on a display portion, or the like. Note that the functions of the electronic devices of embodiments of the present invention are not limited thereto, and the electronic devices can have a variety of functions.

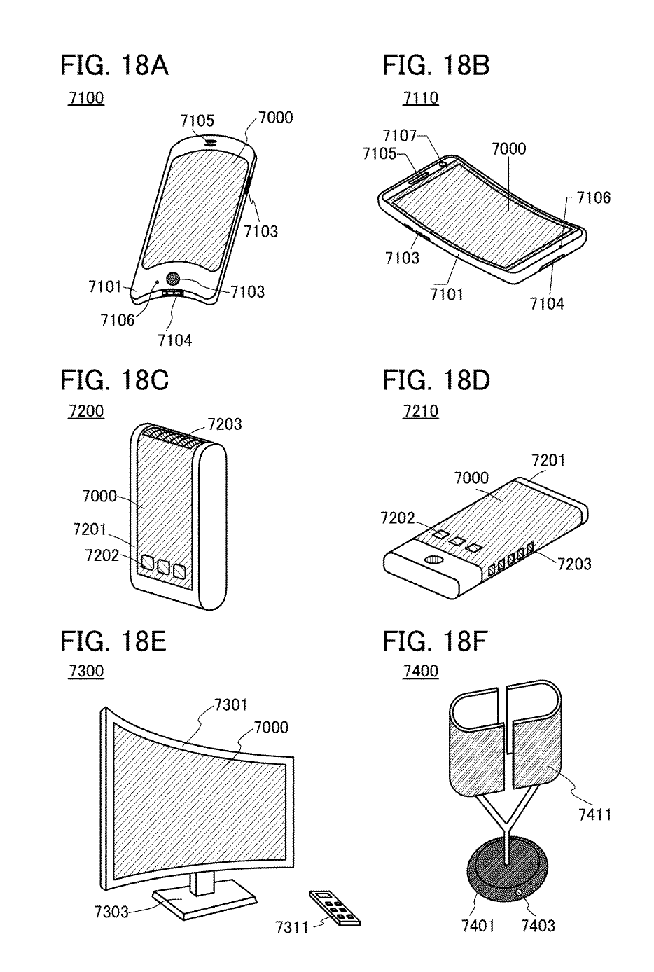

FIGS. 18A to 18E illustrate examples of an electronic device including a display portion 7000 with a curved surface. The display surface of the display portion 7000 is bent, and images can be displayed on the bent display surface. The display portion 7000 may have flexibility.

The display portion 7000 can be formed using the display device or the like of one embodiment of the present invention. One embodiment of the present invention makes it possible to provide a highly reliable electronic device with low power consumption and a curved display portion.

FIGS. 18A and 18B illustrate examples of mobile phones. A mobile phone 7100 illustrated in FIG. 18A and a mobile phone 7110 illustrated in FIG. 18B each include a housing 7101, the display portion 7000, operation buttons 7103, an external connection port 7104, a speaker 7105, a microphone 7106, and the like. The mobile phone 7110 illustrated in FIG. 18B also includes a camera 7107.

Each mobile phone includes a touch sensor in the display portion 7000. Operations such as making a call and inputting a letter can be performed by touch on the display portion 7000 with a finger, a stylus, or the like.

With the operation buttons 7103, power ON or OFF can be switched. In addition, types of images displayed on the display portion 7000 can be switched; for example, switching from a mail creation screen to a main menu screen can be performed.

When a detection device such as a gyroscope or an acceleration sensor is provided inside the mobile phone, the direction of display on the screen of the display portion 7000 can be automatically changed by determining the orientation of the mobile phone (whether the mobile phone is placed horizontally or vertically). Furthermore, the direction of display on the screen can be changed by touch on the display portion 7000, operation with the operation button 7103, sound input using the microphone 7106, or the like.

FIGS. 18C and 18D illustrate examples of portable information terminals. A portable information terminal 7200 illustrated in FIG. 18C and a portable information terminal 7210 illustrated in FIG. 18D each include a housing 7201 and the display portion 7000. Each of the portable information terminals may also include an operation button, an external connection port, a speaker, a microphone, an antenna, a camera, a battery, or the like. The display portion 7000 is provided with a touch sensor. An operation of the portable information terminal can be performed by touching the display portion 7000 with a finger, a stylus, or the like.

Each of the portable information terminals illustrated in this embodiment functions as, for example, one or more of a telephone set, a notebook, and an information browsing system. Specifically, the portable information terminals each can be used as a smartphone. Each of the portable information terminals illustrated in this embodiment is capable of executing, for example, a variety of applications such as mobile phone calls, e-mailing, reading and editing texts, music reproduction, Internet communication, and a computer game.

The portable information terminals 7200 and 7210 can display characters, image information, and the like on its plurality of surfaces. For example, as illustrated in FIGS. 18C and 18D, three operation buttons 7202 can be displayed on one surface, and information 7203 indicated by a rectangle can be displayed on another surface. FIG. 18C illustrates an example in which information is displayed at the top of the portable information terminal. FIG. 18D illustrates an example in which information is displayed on the side of the portable information terminal. Information may be displayed on three or more surfaces of the portable information terminal.

Examples of the information include notification from a social networking service (SNS), display indicating reception of an e-mail or an incoming call, the title of an e-mail or the like, the sender of an e-mail or the like, the date, the time, remaining battery, and the reception strength of an antenna. Alternatively, the operation button, an icon, or the like may be displayed instead of the information.

For example, a user of the portable information terminal 7200 can see the display (here, the information 7203) on the portable information terminal 7200 put in a breast pocket of his/her clothes.

Specifically, a caller's phone number, name, or the like of an incoming call is displayed in a position that can be seen from above the portable information terminal 7200. Thus, the user can see the display without taking out the portable information terminal 7200 from the pocket and decide whether to answer the call.

FIG. 18E illustrates an example of a television set. In a television set 7300, the display portion 7000 is incorporated into a housing 7301. Here, the housing 7301 is supported by a stand 7303.

The television set 7300 illustrated in FIG. 18E can be operated with an operation switch of the housing 7301 or a separate remote controller 7311. The display portion 7000 may include a touch sensor, and can be operated by touch on the display portion 7000 with a finger or the like. The remote controller 7311 may be provided with a display portion for displaying data output from the remote controller 7311. With operation keys or a touch panel of the remote controller 7311, channels and volume can be controlled and a video displayed on the display portion 7000 can be controlled.

Note that the television set 7300 is provided with a receiver, a modem, and the like. A general television broadcast can be received with the receiver. When the television set is connected to a communication network with or without wires via the modem, one-way (from a transmitter to a receiver) or two-way (between a transmitter and a receiver or between receivers) data communication can be performed.

FIG. 18F illustrates an example of a lighting device having a curved light-emitting portion.

The light-emitting portion included in the lighting device illustrated in FIG. 18F can be manufactured using the display device or the like of one embodiment of the present invention. According to one embodiment of the present invention, a highly reliable lighting device with low power consumption and a curved light-emitting portion can be provided.

A light-emitting portion 7411 included in a lighting device 7400 illustrated in FIG. 18F has two convex-curved light-emitting portions symmetrically placed. Thus, all directions can be illuminated with the lighting device 7400 as a center.

The light-emitting portion included in the lighting device 7400 may have flexibility. The light-emitting portion may be fixed on a plastic member, a movable frame, or the like so that a light-emitting surface of the light-emitting portion can be bent freely depending on the intended use.

The lighting device 7400 includes a stage 7401 provided with an operation switch 7403 and the light-emitting portion 7411 supported by the stage 7401.

Note that although the lighting device in which the light-emitting portion is supported by the stage is described as an example here, a housing provided with a light-emitting portion can be fixed on a ceiling or suspended from a ceiling. Since the light-emitting surface can be curved, the light-emitting surface is curved to have a concave shape, whereby a particular region can be brightly illuminated, or the light-emitting surface is curved to have a convex shape, whereby a whole room can be brightly illuminated.

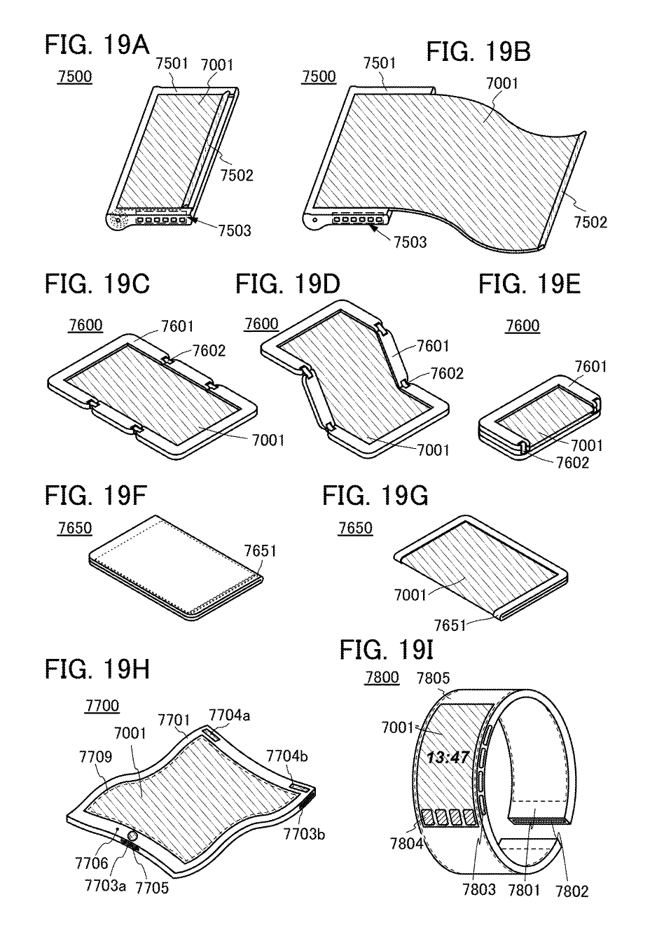

FIGS. 19A to 191 illustrate examples of portable information terminals each including a flexible and bendable display portion 7001.

The display portion 7001 is manufactured using the display device or the like of one embodiment of the present invention. For example, a display device or the like that can be bent with a radius of curvature of greater than or equal to 0.01 mm and less than or equal to 150 mm can be used. The display portion 7001 may include a touch sensor so that the portable information terminal can be operated by touch on the display portion 7001 with a finger or the like. One embodiment of the present invention makes it possible to provide a highly reliable electronic device including a display portion having flexibility.

FIGS. 19A and 19B are perspective views illustrating an example of the portable information terminal. A portable information terminal 7500 includes a housing 7501, the display portion 7001, a display portion tab 7502, operation buttons 7503, and the like.

The portable information terminal 7500 includes a rolled flexible display portion 7001 in the housing 7501. The display portion 7001 can be pulled out by using the display portion tab 7502.

The portable information terminal 7500 can receive a video signal with a control portion incorporated therein and can display the received video on the display portion 7001. The portable information terminal 7500 incorporates a battery. A terminal portion for connecting a connector may be included in the housing 7501 so that a video signal and power can be directly supplied from the outside with a wiring.

By pressing the operation buttons 7503, power ON/OFF, switching of displayed videos, and the like can be performed. Although FIGS. 19A and 19B show an example in which the operation buttons 7503 are positioned on a side surface of the portable information terminal 7500, one embodiment of the present invention is not limited thereto. The operation buttons 7503 may be placed on a display surface (a front surface) or a rear surface of the portable information terminal 7500.

FIG. 19B illustrates the portable information terminal 7500 in a state where the display portion 7001 is pulled out. Videos can be displayed on the display portion 7001 in this state. In addition, the portable information terminal 7500 may perform different displays in the state where part of the display portion 7001 is rolled as shown in FIG. 19A and in the state where the display portion 7001 is pulled out as shown in FIG. 19B. For example, in the state shown in FIG. 19A, the rolled portion of the display portion 7001 is put in a non-display state, reducing the power consumption of the portable information terminal 7500.

Note that a reinforcement frame may be provided for a side portion of the display portion 7001 so that the display portion 7001 has a flat display surface when pulled out.

Note that in addition to this structure, a speaker may be provided for the housing so that sound is output with an audio signal received together with a video signal.

FIGS. 19C to 19E illustrate an example of a foldable portable information terminal. FIG. 19C illustrates a portable information terminal 7600 that is opened. FIG. 19D illustrates the portable information terminal 7600 that is being opened or being folded. FIG. 19E illustrates the portable information terminal 7600 that is folded. The portable information terminal 7600 is highly portable when folded, and is highly browsable when opened because of a seamless large display area.

The display portion 7001 is supported by three housings 7601 joined together by hinges 7602. By folding the portable information terminal 7600 at a connection portion between two housings 7601 with the hinges 7602, the portable information terminal 7600 can be reversibly changed in shape from an opened state to a folded state.

FIGS. 19F and 19G illustrate an example of a foldable portable information terminal. FIG. 19F illustrates a portable information terminal 7650 that is folded so that the display portion 7001 is on the inside. FIG. 19G illustrates the portable information terminal 7650 that is folded so that the display portion 7001 is on the outside. The portable information terminal 7650 includes the display portion 7001 and a non-display portion 7651. When the portable information terminal 7650 is not used, the portable information terminal 7650 is folded so that the display portion 7001 is on the inside, whereby the display portion 7001 can be prevented from being contaminated and damaged.

FIG. 19H illustrates an example of a flexible portable information terminal. A portable information terminal 7700 includes a housing 7701 and the display portion 7001. The portable information terminal 7700 may further include buttons 7703a and 7703b which serve as input means, speakers 7704a and 7704b which serve as sound output means, an external connection port 7705, a microphone 7706, or the like. A flexible battery 7709 can be included in the portable information terminal 7700. The battery 7709 may be arranged to overlap with the display portion 7001, for example.

The housing 7701, the display portion 7001, and the battery 7709 have flexibility. Thus, it is easy to curve the portable information terminal 7700 into a desired shape and to twist the portable information terminal 7700. For example, the portable information terminal 7700 can be folded so that the display portion 7001 is on the inside or on the outside. The portable information terminal 7700 can be used in a rolled state. Since the housing 7701 and the display portion 7001 can be transformed freely in this manner, the portable information terminal 7700 is less likely to be broken even when the portable information terminal 7700 falls down or external stress is applied to the portable information terminal 7700.

The portable information terminal 7700 is lightweight and therefore can be used conveniently in various situations. For example, the portable information terminal 7700 can be used in the state where the upper portion of the housing 7701 is suspended by a clip or the like, or in the state where the housing 7701 is fixed to a wall by magnets or the like.

FIG. 19I illustrates an example of a wrist-watch-type portable information terminal.

The portable information terminal 7800 includes a band 7801, the display portion 7001, an input/output terminal 7802, operation buttons 7803, and the like. The band 7801 has a function as a housing. A flexible battery 7805 can be included in the portable information terminal 7800. The battery 7805 may be arranged to overlap with the display portion 7001, the band 7801, or the like, for example.

The band 7801, the display portion 7001, and the battery 7805 have flexibility. Thus, the portable information terminal 7800 can be easily curved to have a desired shape.

With the operation buttons 7803, a variety of functions such as time setting, ON/OFF of the power, ON/OFF of wireless communication, setting and cancellation of silent mode, and setting and cancellation of power saving mode can be performed. For example, the functions of the operation buttons 7803 can be set freely by the operating system incorporated in the portable information terminal 7800.

By touch on an icon 7804 displayed on the display portion 7001 with a finger or the like, application can be started.

The portable information terminal 7800 can employ near field communication conformable to a communication standard. For example, mutual communication between the portable information terminal and a headset capable of wireless communication can be performed, and thus hands-free calling is possible.

The portable information terminal 7800 may include the input/output terminal 7802. In the case where the input/output terminal 7802 is included in the portable information terminal 7800, data can be directly transmitted to and received from another information terminal via a connector. Charging through the input/output terminal 7802 is also possible. Note that charging of the portable information terminal described as an example in this embodiment can be performed by contactless power transmission without using the input/output terminal.

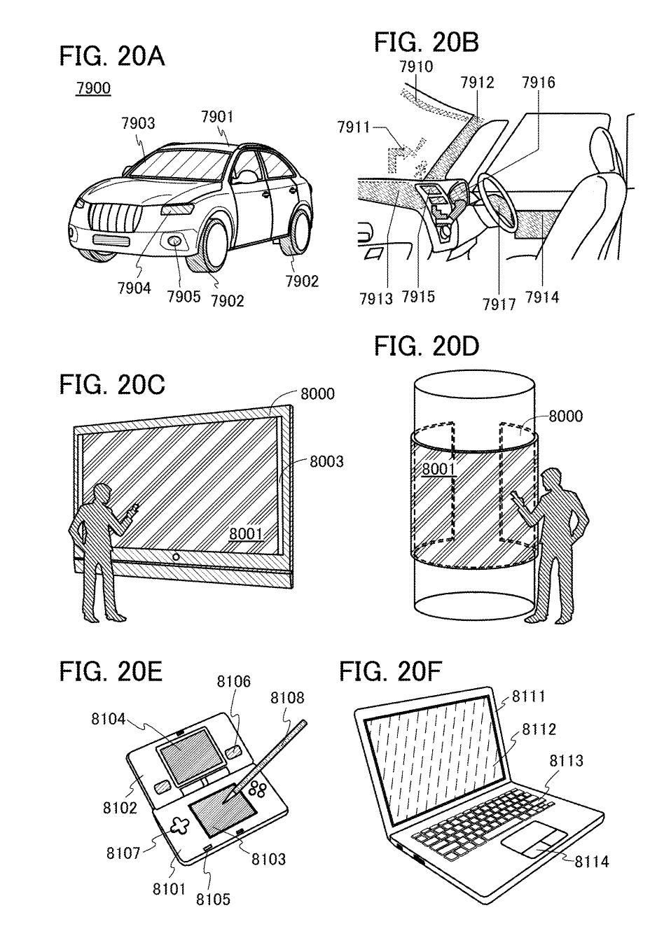

FIG. 20A is an external view of an automobile 7900. FIG. 20B illustrates a driver's seat of the automobile 7900. The automobile 7900 includes a car body 7901, wheels 7902, a windshield 7903, lights 7904, fog lamps 7905, and the like.

The display device of one embodiment of the present invention can be used in a display portion of the automobile 7900. For example, the display device of one embodiment of the present invention can be used in display portions 7910 to 7917 illustrated in FIG. 20B.

The display portion 7910 and the display portion 7911 are provided in the automobile windshield. The display device of one embodiment of the present invention can be a see-through device, through which the opposite side can be seen, by using a light-transmitting conductive material for its electrodes. Such a see-through display device does not hinder driver's vision during the driving of the automobile 7900. Therefore, the display device of one embodiment of the present invention can be provided in the windshield of the automobile 7900. Note that in the case where a transistor or the like is provided in the display device, a transistor having light-transmitting properties, such as an organic transistor using an organic semiconductor material or a transistor using an oxide semiconductor, is preferably used.

A display portion 7912 is provided on a pillar portion. A display portion 7913 is provided on a dashboard. For example, the display portion 7912 can compensate for the view hindered by the pillar portion by showing an image taken by an imaging unit provided on the car body. Similarly, the display portion 7913 can compensate for the view hindered by the dashboard and a display portion 7914 can compensate for the view hindered by the door. That is, showing a video taken by an imaging unit provided on the outside of the automobile leads to elimination of blind areas and enhancement of safety. In addition, showing a video so as to compensate for the area which a driver cannot see makes it possible for the driver to confirm safety easily and comfortably.

The display portion 7917 is provided in a steering wheel. The display portion 7915, the display portion 7916, or the display portion 7917 can display a variety of kinds of information such as navigation data, a speedometer, a tachometer, a mileage, a fuel meter, a gearshift indicator, and air-condition setting. The content, layout, or the like of the display on the display portions can be changed freely by a user as appropriate. The information listed above can also be displayed on the display portions 7910 to 7914.

The display portions 7910 to 7917 can also be used as lighting devices.

A display portion included in the display device of one embodiment of the present invention may have a flat surface. In that case, the display device of one embodiment of the present invention does not necessarily have a curved surface and flexibility.

FIGS. 20C and 20D illustrate examples of digital signages. The digital signages each include a housing 8000, a display portion 8001, a speaker 8003, and the like. Also, the digital signages can each include an LED lamp, operation keys (including a power switch or an operation switch), a connection terminal, a variety of sensors, a microphone, and the like.

FIG. 20D illustrates a digital signage mounted on a cylindrical pillar.

A larger display portion 8001 can provide more information at a time. In addition, a larger display portion 8001 attracts more attention, so that the effectiveness of the advertisement is expected to be increased, for example.

It is preferable to use a touch panel in the display portion 8001 because a device with such a structure does not just display a still or moving image, but can be operated by users intuitively. Alternatively, in the case where the display device of one embodiment of the present invention is used for providing information such as route information or traffic information, usability can be enhanced by intuitive operation.

FIG. 20E illustrates a portable game console including a housing 8101, a housing 8102, a display portion 8103, a display portion 8104, a microphone 8105, a speaker 8106, an operation key 8107, a stylus 8108, and the like.

The portable game console illustrated in FIG. 20E includes two display portions 8103 and 8104. Note that the number of display portions of an electronic device of one embodiment of the present invention is not limited to two and can be one or three or more as long as at least one display portion includes the display device of one embodiment of the present invention.

FIG. 20F illustrates a laptop personal computer, which includes a housing 8111, a display portion 8112, a keyboard 8113, a pointing device 8114, and the like.

The display device of one embodiment of the present invention can be used in the display portion 8112.

At least part of this embodiment can be implemented in combination with any of the other embodiments and the other examples described in this specification as appropriate.

### EXPLANATION OF REFERENCE

10: display device, 11: control portion, 12: photometric portion, 13: driver portion, 14: display portion, 20: pixel unit, 21: first pixel, 21B: display element, 21G: display element, 21R: display element, 22: second pixel, 22B: display element, 22G: display element, 22R: display element, 25: light, 31: arithmetic portion, 32: memory portion, 33: table, 33a: data sheet, 33b: data sheet, 34: table, 40: liquid crystal element, 51: substrate, 60: light-emitting element, 61: substrate, 62: display portion, 64: circuit, 65: wiring, 72: FPC, 73: IC, 100: display panel, 111a: conductive layer, 111b: conductive layer, 112: liquid crystal, 113: conductive layer, 117: insulating layer, 121: insulating layer, 130: polarizing plate, 131: coloring layer, 132: light-blocking layer, 133a: alignment film, 133b: alignment film, 134: coloring layer, 141: adhesive layer, 142: adhesive layer, 191: conductive layer, 192: EL layer, 193a: conductive layer, 193b: conductive layer, 200: display panel, 201: transistor, 204: connection portion, 205: transistor, 206: transistor, 207: connection portion, 210: pixel, 211: insulating layer, 212: insulating layer, 213: insulating layer, 214: insulating layer, 215: insulating layer, 216: insulating layer, 217: insulating layer, 220: insulating layer, 221: conductive layer, 222: conductive layer, 223: conductive layer, 224: conductive layer, 231: semiconductor layer, 242: connection layer, 243: connector, 251: opening, 252: connection portion, 705: insulating layer, 706: electrode, 707: insulating layer, 708: semiconductor layer, 710: insulating layer, 711: insulating layer, 714: electrode, 715: electrode, 722: insulating layer, 723: electrode, 726: insulating layer, 727: insulating layer, 728: insulating layer, 729: insulating layer, 741: insulating layer, 742: semiconductor layer, 744a: electrode, 744b: electrode, 746: electrode, 755: impurity, 771: substrate, 772: insulating layer, 810: transistor, 811: transistor, 820: transistor, 821: transistor, 825: transistor, 826: transistor, 830: transistor, 831: transistor, 840: transistor, 841: transistor, 842: transistor, 843: transistor, 844: transistor, 845: transistor, 846: transistor, 847: transistor, 7000: display portion, 7001: display portion, 7100: mobile phone, 7101: housing, 7103: operation buttons, 7104: external connection port, 7105: speaker, 7106: microphone, 7107: camera, 7110: mobile phone, 7200: portable information terminal, 7201: housing, 7202: operation buttons, 7203: information, 7210: portable information terminal, 7300: television set, 7301: housing, 7303: stand, 7311: remote controller, 7400: lighting device, 7401: stage, 7403: operation switch, 7411: light-emitting portion, 7500: portable information terminal, 7501: housing, 7502: display portion tab, 7503: operation buttons, 7600: portable information terminal, 7601: housing, 7602: hinges, 7650: portable information terminal, 7651: non-display portion, 7700: portable information terminal, 7701: housing, 7703a: button, 7703b: button, 7704a: speaker, 7704b: speaker, 7705: external connection port, 7706: microphone, 7709: battery, 7800: portable information terminal, 7801: band, 7802: input/output terminal, 7803: operation buttons, 7804: icon, 7805: battery, 7900: automobile, 7901: car body, 7902: wheels, 7903: windshield, 7904: lights, 7905: fog lamps, 7910: display portion, 7911: display portion, 7912: display portion, 7913: display portion, 7914: display portion, 7915: display portion, 7916: display portion, 7917: display portion, 8000: housing, 8001: display portion, 8003: speaker, 8101: housing, 8102: housing, 8103: display portion, 8104: display portion, 8105: microphone, 8106: speaker, 8107: operation key, 8108: stylus, 8111: housing, 8112: display portion, 8113: keyboard, and 8114: pointing device.

This application is based on Japanese Patent Application serial no. 2015-201650 filed with Japan Patent Office on Oct. 12, 2015, the entire contents of which are hereby incorporated by reference.

1. A display device comprising:
a first pixel;
a second pixel;
a driver portion;
a photometric portion; and
a control portion,
wherein the first pixel is configured to perform display with reflected light,
wherein the second pixel comprises a light source and is configured to perform display with light from the light source,
wherein the driver portion is configured to drive the first pixel and the second pixel,
wherein the photometric portion is configured to measure and output illuminance of external light, and
wherein the control portion is configured to generate a first gray level output to the first pixel and a second gray level output to the second pixel on the basis of information of the illuminance input from the photometric portion and output the first and second gray levels to the driver portion.

2. The display device according to claim 1,
wherein the control portion generates the first and second gray levels so that the first gray level has a largest value among combinations of the first and second gray levels at which chromaticity and luminance of light obtained by adding light output from the first pixel and light output from the second pixel have predetermined values.

3. The display device according to claim 1,
wherein the control portion comprises an arithmetic portion and a memory portion,
wherein the memory portion stores a table comprising data in which the illuminance is associated with the first and second gray levels, and
wherein the arithmetic portion selects data of the first and second gray levels corresponding to the illuminance from the table and outputs the data to the driver portion.

4. The display device according to claim 1,
wherein the photometric portion is configured to measure and output chromaticity of external light, and
wherein the control portion generates the first and second gray levels on the basis of information of the illuminance and the chromaticity input from the photometric portion.

5. The display device according to claim 1,
wherein the photometric portion is configured to measure and output chromaticity of external light,
wherein the control portion comprises an arithmetic portion and a memory portion,
wherein the memory portion stores a table comprising data in which the illuminance and the chromaticity are associated with the first and second gray levels, and
wherein the arithmetic portion selects data of the first and second gray levels corresponding to the illuminance and the chromaticity from the table and outputs the data to the driver portion.

6. A display device comprising:
a display portion comprising:
first pixels; and
second pixels;
a driver portion;
a photometric portion; and
a control portion,
wherein the first pixels and the second pixels are arranged in a matrix to form the display portion,
wherein the number of the first pixels is a same as that of and the second pixels,
wherein the first pixels and the second pixels are arranged in the display portion with a same pitch,
wherein the first pixels are configured to perform display with reflected light,
wherein the second pixels comprise a light source and is configured to perform display with light from the light source,
wherein the driver portion is configured to drive the first pixels and the second pixels,
wherein the photometric portion is configured to measure and output illuminance of external light, and
wherein the control portion is configured to generate a first gray level output to the first pixels and a second gray level output to the second pixels on the basis of information of the illuminance input from the photometric portion and output the first and second gray levels to the driver portion.

7. The display device according to claim 6,
wherein the control portion generates the first and second gray levels so that the first gray level has a largest value among combinations of the first and second gray levels at which chromaticity and luminance of light obtained by adding light output from the first pixels and light output from the second pixels have predetermined values.

8. The display device according to claim 6,
wherein the control portion comprises an arithmetic portion and a memory portion,
wherein the memory portion stores a table comprising data in which the illuminance is associated with the first and second gray levels, and
wherein the arithmetic portion selects data of the first and second gray levels corresponding to the illuminance from the table and outputs the data to the driver portion.

9. The display device according to claim 6,
wherein the photometric portion is configured to measure and output chromaticity of external light, and
wherein the control portion generates the first and second gray levels on the basis of information of the illuminance and the chromaticity input from the photometric portion.

10. The display device according to claim 6,
wherein the photometric portion is configured to measure and output chromaticity of external light,
wherein the control portion comprises an arithmetic portion and a memory portion,
wherein the memory portion stores a table comprising data in which the illuminance and the chromaticity are associated with the first and second gray levels, and
wherein the arithmetic portion selects data of the first and second gray levels corresponding to the illuminance and the chromaticity from the table and outputs the data to the driver portion.

11. A method for driving a display device, comprising the steps of:
a first step of measuring illuminance of external light with a photometric portion;
a second step of generating first and second gray levels on the basis of information of the illuminance with a control portion; and
a third step of outputting from the control portion a first gray level to a first pixel and a second gray level to a second pixel and performing display with the first pixel and the second pixel in the same period,
wherein the first pixel is configured to perform display with reflected light, and
wherein the second pixel comprises a light source and is configured to perform display with light from the light source.

12. The method for driving a display device according to claim 11,
wherein the control portion generates the first and second gray levels so that the first gray level has the largest value among combinations of the first and second gray levels at which chromaticity and luminance of light obtained by adding light output from the first pixel and light output from the second pixel have predetermined values in the second step.

13. The method for driving a display device according to claim 11,
wherein the control portion selects data of the first and second gray levels corresponding to the illuminance from a table comprising data in which the illuminance is associated with the first and second gray levels in the second step.

14. The method for driving a display device according to claim 11,
wherein the photometric portion measures chromaticity of external light in the first step, and
wherein the control portion generates the first and second gray levels on the basis of information of the illuminance and the chromaticity in the second step.

15. The method for driving a display device according to claim 11,
wherein the photometric portion measures chromaticity of external light in the first step, and
wherein the control portion selects data of the first and second gray levels corresponding to the illuminance and the chromaticity from a table comprising data in which the illuminance and the chromaticity are associated with the first and second gray levels in the second step.

16. The display device according to claim 1,
wherein a display element included in the second pixel is one of an organic light-emitting diode, a light-emitting diode, a quantum-dot light-emitting diode, and a combination of a backlight and a transmissive liquid crystal element.
